(19) United States
(12) Patent Application Publication
(10) Pub. No.: US 2008/0312992 A1
(43) Pub. Date: Dec. 18, 2008

(54) Automatic business process creation method using past business process resources and existing business process

(75) Inventors: Masato Hoshi, Machida (JP); Akane Kinjo, Yokohama (JP); Takashi Takahisa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Ltd., Tokyo (JP)

(21) Appl. No.: 12/012,820

(22) Filed: Feb. 5, 2008

(30) Foreign Application Priority Data
Jun. 14, 2007 (JP) 2007-157398

(51) Int. Cl. G06Q 10/00

(52) U.S. Cl. 705/7

(57) ABSTRACT

A business process creation method comprising the steps of: receiving the input of the business flow to store the input business flow in the storage unit; extracting a business name of a business corresponding to the input business flow and business information containing business tasks constituting the business from the input business flow; retrieving at least one similar business process from the accumulated business processes based on the extracted business information; extracting a flow shape indicating a shape of the business flow from the input business flow; calculating similarities between the input business flow and the retrieved at least one similar business process; receiving selection of a business process from the retrieved at least one similar business process; and creating a business process corresponding to the input business flow to output the created business process in an executable format based on the selected business process.

### CLAIM OF PRIORITY

The present application claims priority from Japanese patent application JP 2007-157398 filed on Jun. 14, 2007, the content of which is hereby incorporated by reference into this application.

### BACKGROUND OF THE INVENTION

This invention relates to a technology of creating a business process based on an input business flow.

In actually pursued business, it is often the case that a business flow defining a business procedure has already been established. In the case of systematizing business to be carried out, however, it takes a number of man-hours to create new physical definition information (executable format in system) of a business process which includes physical definition of a business process execution language for web services (BPEL), service physical definition, and activity physical definition based on logical information of a business process constituting an existing business flow.

Thus, if a new business process can be created by retrieving logical information and physical definition information of business processes accumulated as past resources, and automatically reconfiguring BPEL physical definition, service physical definition, and activity physical definition, development man-hours can be greatly reduced. Moreover, identical or similar business procedures can be integrated.

However, in the case of retrieving the accumulated business processes by keywords, variance may disadvantageously occur in retrieval results among persons in charge. To counter this problem, a technology of retrieving accumulated business processes based on a hierarchical structure of a business flow is disclosed (refer to JP 2006-285313 A).

According to the technology disclosed in JP 2006-285313 A, first, a business flow similar to business contents of a client is presented as “first edition of client business process model” at an early date. A business process model of more similar contents is retrieved and extracted based on a keyword regarding business, and a hierarchical relation of business processes.

### SUMMARY OF THE INVENTION

However, the technology disclosed in JP 2006-285313 A is a technology for retrieving a frame of a business process model of high-order business only by a keyword, and verifying a hierarchical structure of low-order business (matching verification of interfaces with respect to the frame of high-order business thus retrieved), thereby selecting a most suitable business process. Thus, while suitability of the low-order business can be maintained, there may be no suitability as a whole including a feature of the entire business and a frame size of a business process model of the high-order business.

According to the technology disclosed in JP 2006-285313 A, only a model is retrieved, which is not an actually executable format. Thus, development efficiency cannot be greatly improved.

According to the technology disclosed in JP 2006-285313 A, only a business flow whose interface matches is a target of retrieval. Thus, even the same business does not become a target of retrieval unless a business flow having a plurality of interfaces is defined, and retrieval efficiency is not high.

This invention has been developed to solve the aforementioned problems, and it is an object of this invention to reduce man-hours necessary for business systematization, and to integrate business procedures by creating a business process in an executable format based on information such as a business task and a flow shape constituting a business flow.

A representative aspect of this invention is as follows. That is, there is provided a business process creation method executed in a business process creation device for creating a business process for defining a business based on accumulated business processes. The business process creation device has a processor, a storage unit accessible from the processor, and a business flow input unit for receiving an input of a business flow including a business procedure. In the business process creation method, the business flow input unit receives the input of the business flow to store the input business flow in the storage unit. The processor extracts a business name of a business corresponding to the input business flow and business information containing business tasks constituting the business from the input business flow. The processor retrieves at least one similar business process from the accumulated business processes based on the extracted business information. The processor extracts a flow shape indicating a shape of the business flow from the input business flow. The processor calculates similarities between the input business flow and the retrieved at least one similar business process, based on the extracted flow shape and a flow shape of a business flow of the retrieved at least one similar business process. The processor receives selection of a business process from the retrieved at least one similar business process. The processor creates a business process corresponding to the input business flow to output the created business process in an executable format based on the selected business process.

According to an aspect of this invention, business efficiency can be improved by using past business process resources to automatically create an executable format of a business process and to reduce man-hours for business systematization, and by integrating similar business procedures.

### BRIEF DESCRIPTION OF THE DRAWINGS

The present invention can be appreciated by the description which follows in conjunction with the following figures, wherein:

FIG. 1 is a block diagram showing a hardware configuration of a computer system in accordance with an embodiment of this invention;

FIG. 2 is a block diagram showing a logical configuration of a similar business process extraction device stored in a main memory in accordance with the embodiment of this invention;

FIG. 3 is an explanatory diagram showing information stored in an external storage system in accordance with the embodiment of this invention;

FIG. 4 is a flowchart showing an outline of a first-half process of a business process creation method in accordance with the embodiment of this invention;

FIG. 5 is a flowchart showing an outline of a second-half process of the business processing creation method in accordance with the embodiment of this invention;

FIG. 6 is an explanatory diagram showing an example of a business flow of an estimation business read from a business flow input device in accordance with the embodiment of this invention;

FIG. 7 is an explanatory diagram showing an example of a business flow of a final estimate decision in accordance with the embodiment of this invention;

FIG. 8 is a flowchart showing a procedure of a flow shape information acquisition process of an input business flow in accordance with the embodiment of this invention;

FIG. 9 is an explanatory diagram showing a business flow of a estimation business which is in a grid-developed status in accordance with the embodiment of this invention;

FIG. 10 is an explanatory diagram showing a modified example of a business flow of a estimation business and a result of grid-developing a modified example in accordance with the embodiment of this invention;

FIG. 11 is a flowchart showing a procedure of a flow shape information acquisition process in accordance with the embodiment of this invention;

FIG. 12 is an explanatory diagram showing an example of a business flow and a flow shape represented as a grid in accordance with the embodiment of this invention;

FIG. 13 is a flowchart showing a procedure of extracting a business process similar to an input business flow in accordance with the embodiment of this invention;

FIG. 14 is an explanatory diagram showing a synonym table for storing a business name similar to a designated business in accordance with the embodiment of this invention;

FIG. 15 is an explanatory diagram showing a business table for storing correspondence between a business and a business process in accordance with the embodiment of this invention;

FIG. 16 is a flowchart showing a business task matching keyword process for comparing business tasks constituting an input business flow with business tasks constituting an extracted business processes in accordance with the embodiment of this invention;

FIG. 17 is an explanatory diagram showing a business task table for defining business tasks constituting a business process in accordance with the embodiment of this invention;

FIG. 18 is a flowchart showing a process of normalizing a flow shape in accordance with the embodiment of this invention;

FIG. 19 is an explanatory diagram showing a business process shape information table in accordance with the embodiment of this invention;

FIG. 20 is an explanatory diagram showing a modified example of a business process shape information table in accordance with the embodiment of this invention;

FIG. 21 is an explanatory diagram showing deletion of an activity indicating control information in accordance with the embodiment of this invention;

FIG. 22 is an explanatory diagram showing a flow shape obtained from a business process shape information table and a normalized flow shape in accordance with the embodiment of this invention;

FIG. 23 is a flowchart showing a process of comparing a flow shape of a business flow in accordance with the embodiment of this invention;

FIG. 24 is an explanatory diagram showing an example of an input business flow of a flow shape in accordance with the embodiment of this invention;

FIG. 25 is an explanatory diagram showing an example of a flow shape compared with an input business flow of a flow shape in accordance with the embodiment of this invention;

FIG. 26 is an explanatory diagram showing a list of flow shapes corresponding to business process names similar to an input business flow in accordance with the embodiment of this invention;

FIG. 27 is a flowchart showing a matching process of pieces of flow shape information in accordance with the embodiment of this invention;

FIG. 28 is a flowchart showing a procedure of judging similarity of branch conditions between business flows in accordance with the embodiment of this invention;

FIG. 29 is an explanatory diagram showing a condition information definition table in accordance with the embodiment of this invention;

FIG. 30 is a flowchart showing a procedure of displaying and selecting business processes similar to an input business flow in accordance with the embodiment of this invention;

FIG. 31 is an explanatory diagram showing a result of normalizing a similarity from each viewpoint of a business process name similar to an input business flow in accordance with the embodiment of this invention;

FIG. 32 is an explanatory diagram showing a business flow of a business process where business tasks common to an input business flow are discriminated to be displayed in accordance with the embodiment of this invention;

FIG. 33 is a flowchart showing an automatic message format correction process in accordance with the embodiment of this invention;

FIG. 34 is an explanatory diagram showing a business flow which includes a business task including business tasks in accordance with the embodiment of this invention;

FIG. 35 is an explanatory diagram showing an example of a variable definition table in accordance with the embodiment of this invention;

FIG. 36 is an explanatory diagram showing correspondence between data held by a business process of a calling source and data necessary for a business process of a calling destination in accordance with the embodiment of this invention;

FIG. 37 is an explanatory diagram showing correspondence between data held by a business process of a calling source and data necessary for a business process of a calling destination in accordance with the embodiment of this invention;

FIG. 38 is an explanatory diagram showing correspondence between data held by a business process of a calling source and data necessary for a business process of a calling destination in accordance with the embodiment of this invention;

FIG. 39 is an explanatory diagram showing correspondence between data held by a business process of a calling source and data necessary for a business process of a calling destination in accordance with the embodiment of this invention;

FIG. 40 is an explanatory diagram showing an example where a data conversion process is actually added to a BPEL file indicating a business process of a calling source in accordance with the embodiment of this invention;

FIG. 41 is an explanatory diagram showing an example of an XML schema for defining a data format of a calling source in accordance with the embodiment of this invention;

FIG. 42 is a flowchart illustrating a procedure of outputting a business flow of an executable format newly created based on a selected business process in accordance with the embodiment of this invention;

FIG. 43 is an explanatory diagram showing a BPEL physical definition correspondence table in accordance with the embodiment of this invention; and

FIG. 44 is an explanatory diagram showing an activity physical definition correspondence table in accordance with the embodiment of this invention.

### DETAILED DESCRIPTION OF THE PREFERRED EMBODIMENTS

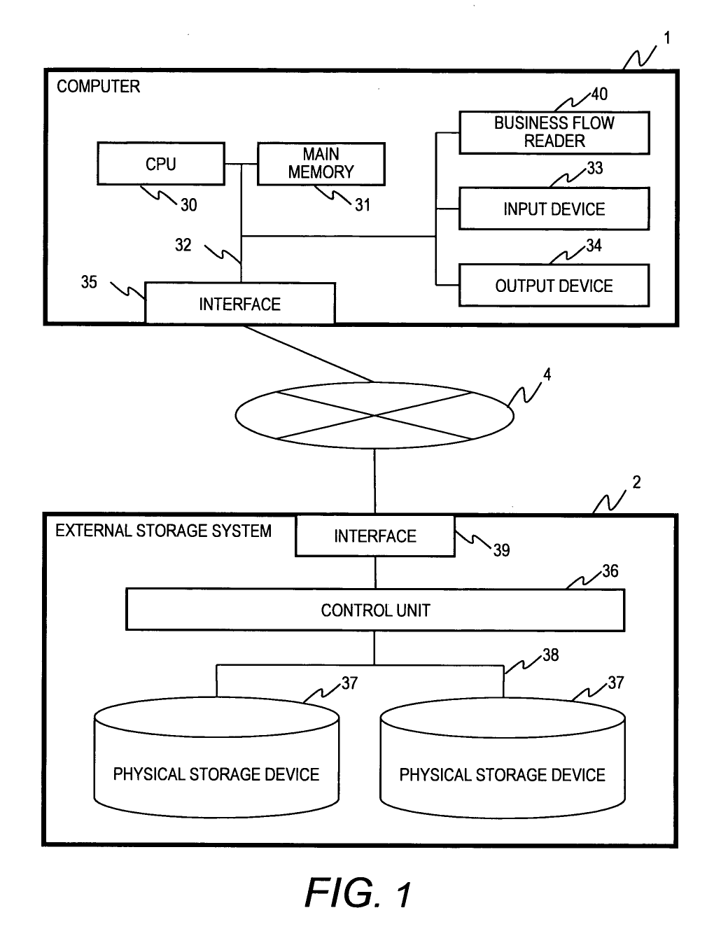

FIG. 1 illustrates a hardware configuration of a computer system according to an embodiment of this invention. The computer system of the embodiment of this invention includes a computer 1 and an external storage system 2. The computer 1 and the external storage system 2 are intercoupled via a network 4. The external storage system 2 may be included in the computer 1.

The computer 1 includes a CPU 30, a main memory 31, an input device 33, an output device 34, an interface 35, and a business flow input device 40. The CPU 30, the main memory 31, the input device 33, the output device 34, the interface 35, and the business flow input device 40 are intercoupled via a bus 32.

The CPU 30 executes various programs stored in the main memory 31 to carry out various arithmetic operations. The main memory 31 stores programs, information necessary for executing the programs, and a processing result of the programs. The main memory 31 may be a volatile or nonvolatile memory.

The input device 33 is an interface for entering information necessary for the computer 1. The input device 33 is, for example, a keyboard or a mouse. The output device 34 is a device for outputting information such as a processing result to the outside. The output device 34 is, for example, a display. The interface 35 is coupled to the network 4.

The business flow input device 40 is a device for entering a business flow described by a flowchart or a business process modeling notation (BPMN) or the like. The input business flow is analyzed to be stored in the external storage system 2. The business flow input device 40 is, for example, a scanner. The business flow input device 40 may be coupled to the computer 1 via the network.

The external storage system 2 provides a storage volume to the computer 1 by a logical volume including at least one physical storage devices 37. The external storage system 2 stores a business flow input via the business flow input device 40, a result of analyzing the business flow, and information for analysis in the provided storage volume.

The external storage system 2 includes a control unit 36, a physical storage device 37, and an interface 39. The control unit 36, the physical storage device 37, and the interface 39 are intercoupled via a bus 38.

The control unit 36 includes a CPU and a memory (not shown), receives a data reading/writing request from the computer 1 to execute a requested process. The physical storage device 37 stores data. The physical storage device 37 is, for example, a magnetic disk device. The interface 39 is coupled to the network 4.

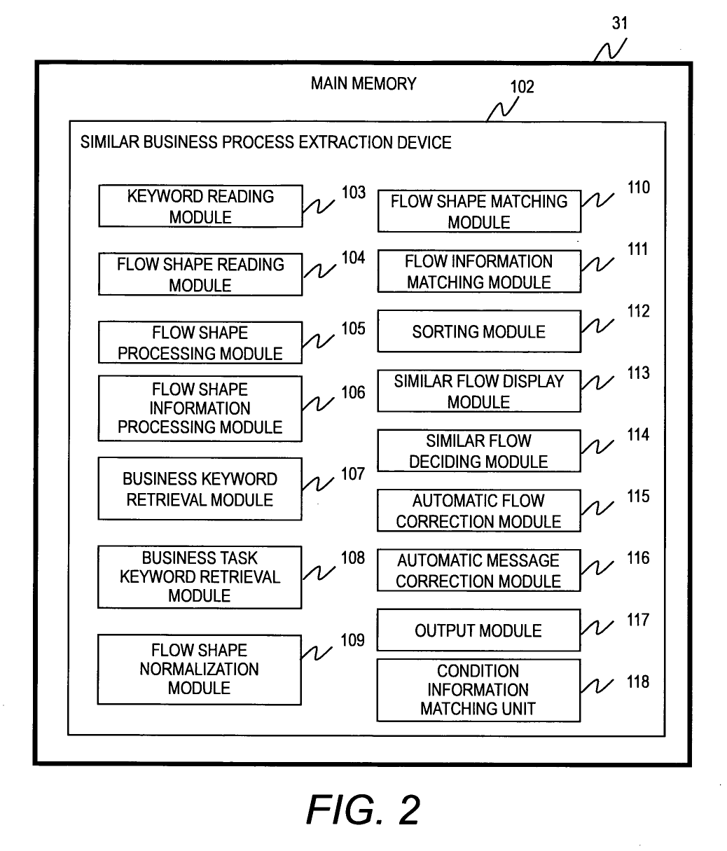

FIG. 2 illustrates a logical configuration of a similar business process extraction device 102 stored in the main memory 31 according to the embodiment of this invention.

The similar business process extraction device 102 retrieves a business process similar to the business flow input via the business flow input device 40, and outputs an automatically corrected result based on the input business flow.

The similar business flow extraction device 102 includes a keyword reading module 103, a flow shape reading module 104, a flow shape processing module 105, a flow shape information processing module 106, a business keyword retrieval module 107, a business task keyword retrieval module 108, a flow shape normalization module 109, a flow shape matching module 110, a flow information matching module 111, a sorting module 112, a similar flow display module 113, a similar flow deciding module 114, an automatic flow correction module 115, an automatic message format correction module 116, an output module 117, and a condition information matching module 118.

The keyword reading module 103 extracts business information such as a business name, a business task name, or a key word of a conditional equation from the business flow input via the business flow input device 40.

The flow shape reading module 104 extracts a flow shape from the business flow input via the business flow input device 40.

The flow shape processing module 105 fixes a “start point” and an “end point” of a flow from the flow shape extracted by the flow shape reading module 104, and develops grid therebetween for each branch pattern.

The flow shape information processing module 106 calculates the number of lines connected to a point indicating a business or a business task from the flow shape extracted by the flow shape reading module 104 to come up with an index.

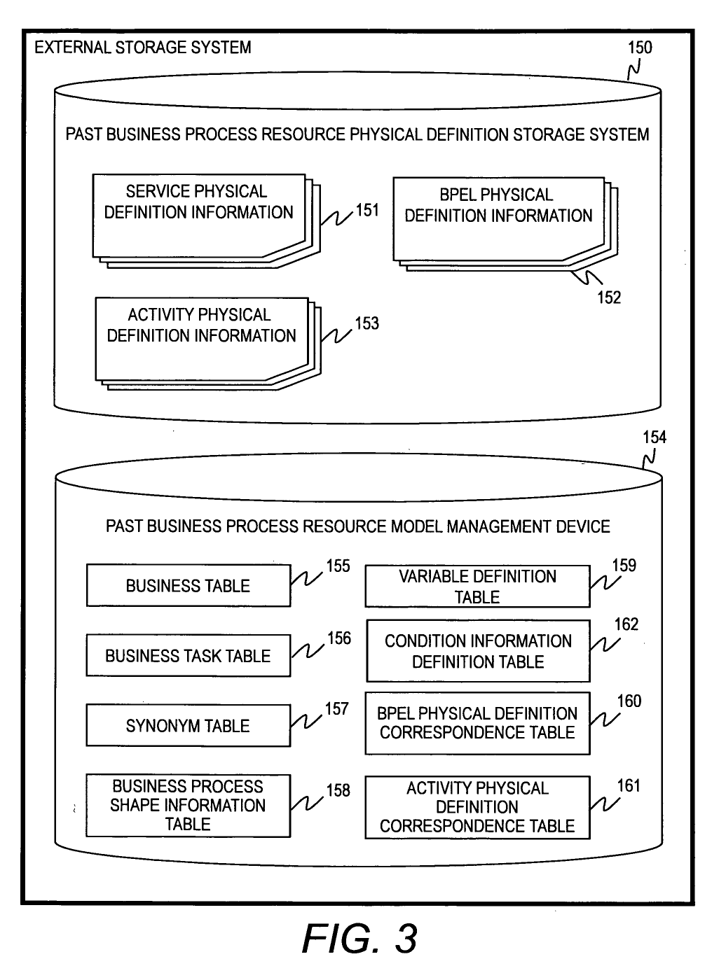

The business keyword retrieval module 107 obtains a synonym from a synonym table 157 described below referring to FIG. 3 by using the business name obtained by the keyword reading module 103 as a key. By using the obtained business name and the synonym as a business name, a business process name is obtained from a business table 155 described below referring to FIG. 3. BPEL indicated by the obtained business process name is for executing a business indicated by the business name.

The business task keyword retrieval module 108 obtains a synonym from the synonym table 157 by using the business task name obtained by the keyword reading module 103 as a key. By designating the business process name obtained by the business keyword retrieval module 107 as a business process name of a business task table 156 described below referring to FIG. 3, and the obtained business task name and synonym as a business name of the business task table 156, the number of matched business task names is obtained. If the number of matched business task name is large, business contents are similar.

The flow shape normalization module 109 obtains shape information from a business process shape information table 158 described below referring to FIG. 3 by using the business process name obtained by the business keyword retrieval module 107 as a key. Control information not related directly to a business is deleted from the obtained flow shape to obtain a normalized flow shape. By deleting control information contained in the BPEL to normalize the flow shape, accuracy of flow shape comparison is improved.

The flow shape matching module 110 physically compares the flow shape extracted from the business flow input via the flow shape reading module 104 with a flow shape obtained from a business process stored by the flow shape normalization module 109. The flow shape comparison is carried out for each branch. When flow shapes are more similar, business flows are more similar. The number of points constituting a flow shape matches the number of business tasks constituting a business flow, and thus a business flow of similar size is easily judged to be similar.

By using a branch shape of processes contained in the business flow as information of characteristics of a flow shape, the flow shape matching module 110 compares the flow shape extracted from the input business flow with the flow shape obtained from the stored business process.

Branch information targets flow shapes having three or more lines connected to a point. If the number of lines connected to a point is 1, there are only start and end points. If the number is 2, a business task has no branches. A sum total of results of multiplying (number of lines −1) by the number of points having the number of lines is set as an evaluation value. It is to prevent input overlapping that 1 is subtracted from the number of lines to calculate the evaluation value. When a value of an evaluation equation is nearer, flow characteristics are more similar. For selection of a business process, because a flow having a larger number of branch processes takes precedence, a difference in value of the evaluation equation is multiplied by 0.5 to be weighted. This evaluation method will be described below in detail. It should be noted that when a difference in value of the evaluation equation is smaller, a similarity is higher.

Evaluation by the flow shape matching module 110 is not affected by the number of business tasks constituting a business flow. Accordingly, a business process having a flow shape where a branch is different in size but similar in shape takes precedence.

The sorting module 112 sorts business processes in ascending order of similarity based on the results obtained by the flow shape normalization module 109, the flow shape matching module 110, and the flow information matching module 111, thereby controlling a user to select a retrieved business process.

The similar flow display module 113 displays a difference in shape between the similar flow selected and normalized by the user at the sorting module 1122 and the business flow extracted by the flow shape reading module 104. The business task commonly contained in the input business flow and the normalized business process is displayed to be easily recognized, thereby enabling the user to visually judge similarity.

The similar flow deciding module 114 selects a similar business flow displayed by the similar flow display module 113.

When a business name or a business task name is retrieved based on a synonym by the business keyword retrieval module 107 or the business task keyword retrieval module 108, because it deviates from the BPEL, the automatic flow correction module 115 automatically changes an activity name of the BPEL to a business task name.

If a type of an activity corresponding to the business process name decided by the similar flow deciding module 114 is “BP” indicating a business, BPEL indicating the business has to be retrieved again. In this case, because an I/O message format varies from one BPEL to another, the automatic message format correction module 116 refers to a variable definition table 159 to automatically add data conversion, thereby correcting the message format.

The output module 117 refers to a BPEL physical definition correspondence table 160 to obtain BPEL physical definition information 152 as BPEL corresponding to the business process name decided by the similar flow deciding module 114. Similarly, the output module 117 obtains an activity name corresponding to the business process name decided by the similar flow deciding module 114, and refers to an activity physical definition correspondence table 161 to obtain service physical definition information 151 and activity physical definition information 153. Additionally, the output module 117 reflects and outputs correction results of the automatic flow correction module 115 and the automatic message format correction module 116.

The condition information matching module 118 compares the input business flow conditional equation obtained by the keyword reading module 103 with a conditional equation obtained by designating the business process name obtained by the business keyword retrieval module 107. Specifically, for the input business flow conditional equation and the conditional equation obtained by designating the business process name, evaluation is made by two indexes, i.e., an establishment condition and a value of a condition. When the number of two matched indexes is larger, a similarity is higher.

FIG. 3 illustrates information stored in the external storage system 2 according to the embodiment of this invention. The information stored in the external storage system 2 includes a past business process resource physical definition storage system 150 and a past business process resource model management device 154.

The past business process resource physical definition storage system 150 stores pieces of business process physical information which are resources accumulated by past businesses. Specifically, the past business process resource physical definition storage system 150 includes service physical definition information 151, BPEL physical definition information 152, and activity physical definition information 153.

The service physical definition information 151 stores physical definition (application) of services executed by an activity stored in the activity physical definition information 153.

The BPEL physical definition information 152 stores BPEL and information necessary for executing the BPEL. The information necessary for executing the BPEL includes a BPEL file, a schema file for defining I/O information, and a data conversion definition file for converting I/O data.

The activity physical definition information 153 stores physical definition necessary for executing an activity. In reality, as the activity executes services, the physical definition is managed corresponding to the services. The service physical definition is saved in the service physical definition information 151.

The past business process resource model management device 154 stores pieces of logical model information of business processes which are valid resources accumulated from past businesses. Specifically, the past business process resource model management device 154 includes the business table 155, the business task table 156, the synonym table 157, the business process shape information table 158, the variable definition table 159, the BPEL physical definition correspondence table 160, the activity physical definition correspondence table 161, and a condition information definition table 162.

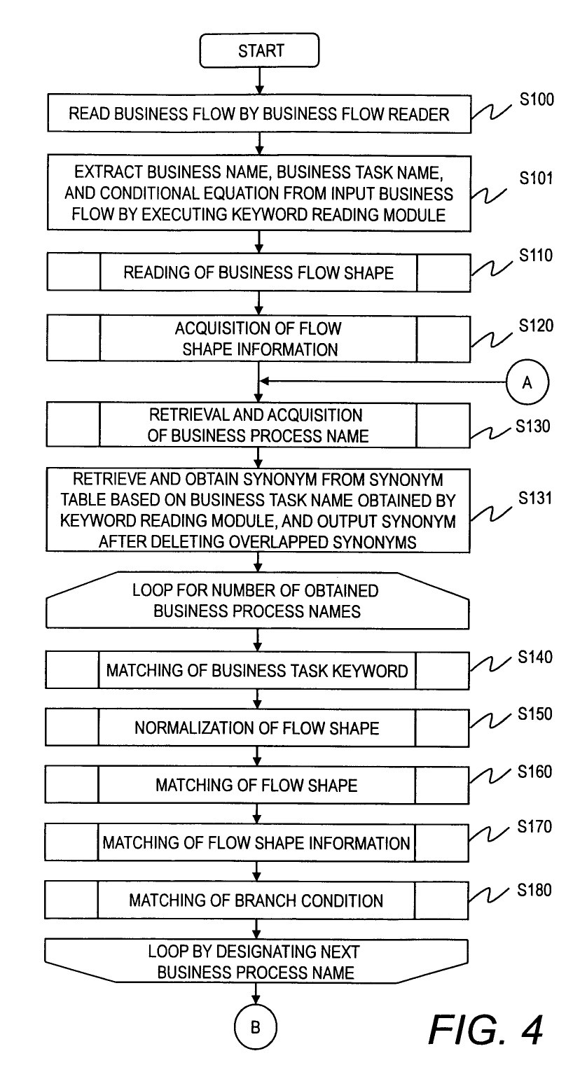

The business table 155 stores correspondence between a business name and a business process name indicating BPEL for executing a business. In a flow of business execution, because a plurality of patterns are present, if retrieval is carried out by a business name, a plurality of business names are retrieved. This process will be described below in detail referring to FIG. 4.

The business task table 156 stores correspondence between a business process name indicating a business and a business task which is a sub-business constituting a business. Generally, because a business includes a plurality of business tasks, when retrieval is carried out by a business name, a plurality of business tasks are retrieved.

The business task table 156 includes, because a business task may further constitute a business in some cases, a type for identifying this task. A type is “BP” when a business task constitutes a business. “ACT” is set in the case of a business task which is a minimum unit. When a type is “ACT”, the business task itself is an activity, and corresponds to a service.

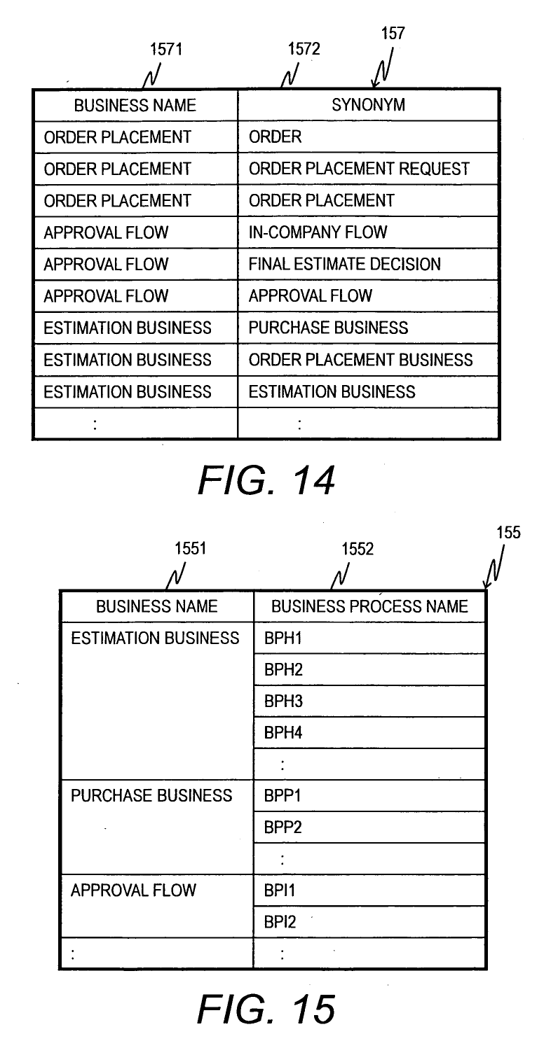

The synonym table 157 defines correspondence between a term such as a business name used for a business process and a synonym which is a term similar to the term. Details will be given below referring to FIG. 14.

The business process shape information table 158 stores flow shape information of a business process. The business process shape information table 158 includes a business process name, shape information, and business flow information.

The variable definition table 159 stores I/O information of BPEL indicated by a business process name indicating a business. A code is assigned to a tag of XML input/output from BPEL to give a logical meaning, and a business process name and XPath as tag information of XML are managed corresponding to the code.

The BPEL physical definition table 160 stores a relation between a business process name and BPEL physical definition information 152.

The activity physical definition correspondence table 161 stores a relation between an activity name and activity physical definition information 153.

The condition information definition table 162 stores a relation between a business name and a condition and a value of the condition used in the BPEL indicated by the business process name.

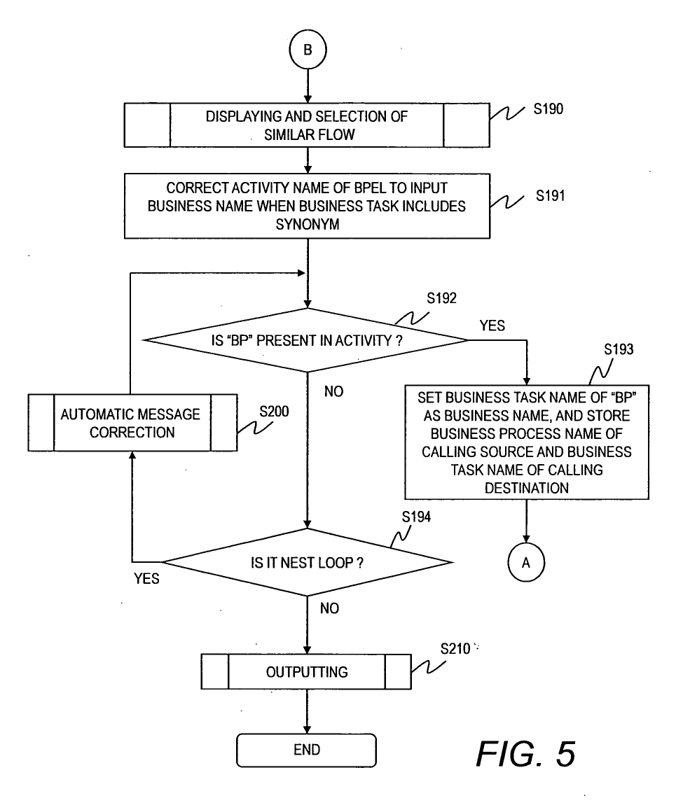

A process of the business process creation method according to the embodiment of this invention will be described. First, referring to FIGS. 4 and 5, an outline of the process will be given.

FIG. 4 is a flowchart illustrating an outline of a first-half process of the business process creation method according to the embodiment of this invention. This process is executed by processing various programs stored in the main memory 31 of the computer 1 by the CPU 30.

Upon start of the process, the computer 1 first reads a business flow via the business flow input device 40 (S100).

The CPU 30 reads a business name, a business task, and a conditional equation contained in the business flow by the keyword reading module 103 (S101). A flow shape of the business flow is extracted by the flow shape reading module 104 (S110). A flow shape of the business flow in which grid is developed by the flow shape processing module 105 is extracted (S120).

The CPU 30 retrieves a business process similar to a business corresponding to the input business flow by the business keyword retrieval module 107 (S130). Based on the business task name obtained in the step S101, searching is carried out in the synonym table 157, and overlapping synonyms are deleted to store the rest in the main memory 31 (S131).

The CPU 30 hereinafter compares business processes with the business process obtained in the step S130 to calculate similarities for information of the input business flow (S140 to S180).

The CPU 30 retrieves business task names of business processes to be compared, and calculates the number of those which match business tasks constituting the input business flow (S140).

The CPU 30 obtains, based on a business process name retrieved in the step S130, a flow shape of the business process to normalize it (S150). The normalization of the flow shape is carried out in such a manner that processes unrelated to a business itself such as data conversion are deleted, and only business tasks related to the business itself constitute a business flow. Details will be described below.

The CPU 30 compares the input business flow with the normalized business flow based on the shape of the business flow (S160). Based on flow shape information calculated from the flow shape of the business flow, the CPU 30 compares the input business flow with the normalized business flow (S170). Based on branch conditions contained in the business flow, the CPU 30 compares the input business flow with the normalized business flow (S180).

Through this process, the input business flow is compared with business processes extracted from past resources to calculate similarity from each viewpoint. In the second half of the process, based on the calculated similarity or the like, a business process is selected to create a new business flow.

FIG. 5 is a flowchart illustrating the second-half process of the business processing creation method according to the embodiment of this invention.

The CPU 30 extracts a business process highly likely to be similar based on the input business flow. Upon calculation of similarity of each business process for each viewpoint, the CPU 30 displays each business process with related information to receive selection of a business process (S190). Based on the input business flow, the CPU 30 corrects the selected business process (S191).

If a business task constituting the input business flow further includes a plurality of business tasks (result of S192 is “YES”), the CPU 30 recursively executes a process of step S200 and after by using the business task as a business name (S193).

If all the business tasks contained in the business flow includes single business tasks (result of S192 is “NO”), the CPU 30 judges whether the process is a process from a nested loop (if this process is executed from the step S193) (S194). If the process is a process from a nested loop (result of S310 is “YES”), message format information is corrected to match an interface with a high-order business (S200).

Upon end of the process for all the businesses, the CPU 30 creates a business process corresponding to the input business flow to output definition information of an executable format business flow described by BPEL or the like (S210).

The outline of this process has been described. Each process will be described in detail. According to the embodiment of this invention, a business flow of a paper medium is read to be input. Accumulated past resources are referred to retrieve a similar business process, and the similar business process is corrected if necessary to create a new business process. Then, the new business process is output in an executable format.

First, the reading step S100 of the business flow will be described. In the step S100, as described above, the business flow is read from the business flow input device 40. According to the embodiment of this invention, the business flow of the paper medium is read. Thus, the business flow input device 40 is, for example, a scanner. Without using the business flow input device 40, necessary information may be input via the input device 33.

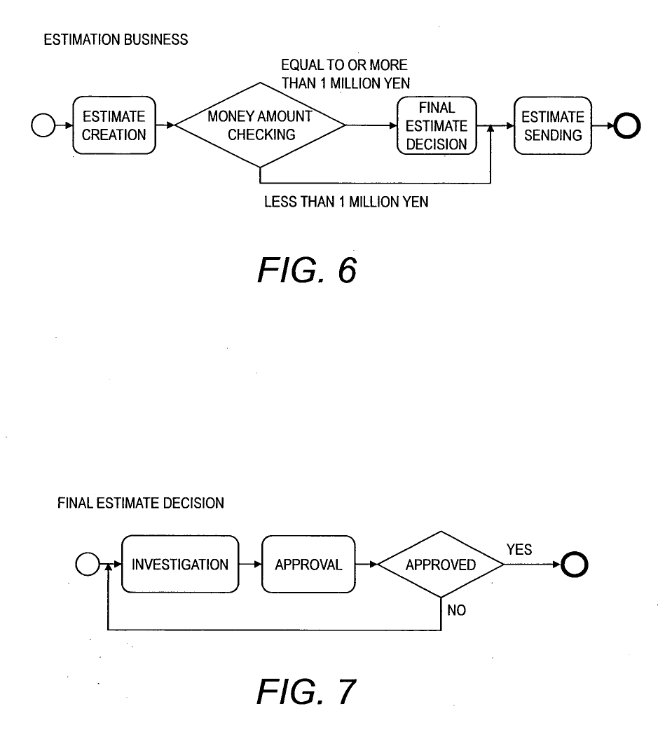

FIG. 6 illustrates an example of a business flow of an estimation business read from the business flow input device 40 according to the embodiment of this invention. The business flow shown in FIG. 6 is described according to BPMN. Unless otherwise specified, the business flow is described based on BPMN.

According to the BPMN, a business flow is represented by an event, an activity, a gateway (condition branch), or a sequence flow. The event indicates an event “generated” during a business process. The event is indicated by a blank circle. Types of events are classified into three, i.e., start, middle, and end based on time affecting the flow.

The activity corresponds to a business or a business task, and is a generic term for work carried out by a company. For the activity, there is a task not broken down into more detailed levels, or a sub-process including a more detailed process. The activity is represented by a rectangle having round corners.

The gateway is used for controlling branching or converging of a sequence flow. Accordingly, the gateway judges path branching, combining, or coupling.

The sequence flow is used for indicating an executing sequence of activities in a process.

Thus, the business flow described by the BPMN is represented by a shape defined for each component. As a result, the business flow input device 40 such as a scanner can analyze read image data, recognize shapes of components, and classify components into types. A character string such as a business name can be extracted by a conventional technology such as a character recognition technology.

The business flow may not be described based on the BPMN. The input business flow can be analyzed as long as it is based on a specific description method such as a flowchart.

Referring to FIG. 6, the estimation business includes four businesses, i.e., estimate creation, money amount checking, final estimate decision, and estimate sending. According to an overall business flow, first, an estimate is created to check costs of estimation. If costs are equal to or more than 1 million yen, final estimate decision must be made. Lastly, the estimate is sent to a predetermined address to complete the estimation business.

More specifically, the business flow of the estimation business includes events indicating a start and an end, activities of estimate creation, final estimate decision, and estimate sending, and a gateway of money amount checking. The activities of estimate creation and estimate sending are business tasks not broken down into more detailed levels, and directly correspond to services. The final estimate decision is a business including a plurality of business tasks, and a more detailed business flow will be described below referring to FIG. 7. The gateway of money amount checking branches a process according to whether a sum total is 1 million yen or more.

FIG. 7 illustrates an example of a business flow of the final estimate decision according to the embodiment of this invention. The final estimate decision business includes activities indicating business tasks of investigation and approval, and a gateway for judging whether an estimate has been approved. The final estimate decision business receives estimate information, investigates contents, and approves the estimate according to a result. If approved, final estimation decision is completed. Thus, according to the BPMN, the business flow can be represented by a nest.

In the step S101, a keyword included in the business flow is extracted. In the step S101, the keyword reading module 103 extracts a business name, a business task name, and a keyword of a conditional equation from the business flow read from the business flow input device 40.

As a method of extracting a keyword, for example, there is a method based on a relation between a shape of a graphic object indicating an activity and a position of describing a keyword. Specifically, a character string surrounded with a square having round corners is recognized as a business task. When a lozenge diagram indicating a gateway is extracted, a character string described at a shortest distance from a sequence flow extending from the gateway can be recognized as a conditional equation.

Referring to FIG. 6, “estimation business”, “estimate creation”, “money amount checking”, “Final estimate decision”, and “estimate sending”, and “equal to or more than 1 million yen” and “less than 1 million yen” can be extracted for the business name, the business task names, and the conditional equations, respectively.

Subsequently, according to the business process creation method of this invention, by executing the flow shape reading module 104, a flow shape is extracted from the input business flow (S110).

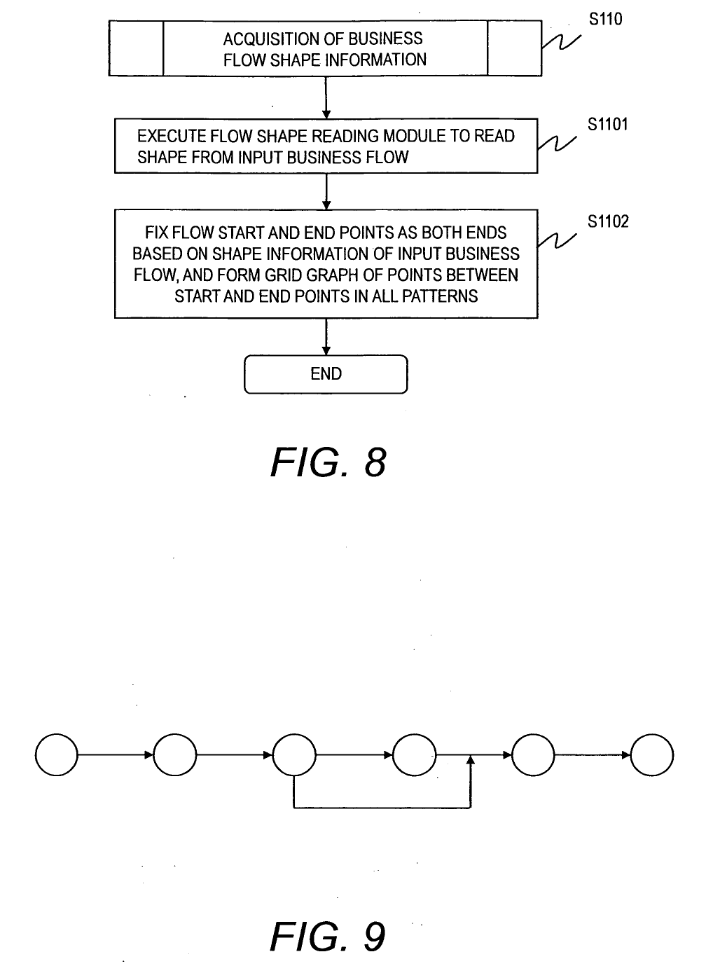

FIG. 8 is a flowchart illustrating a procedure of a flow shape information acquisition process of the input business flow according to the embodiment of this invention.

The CPU 30 executes the flow shape reading module 104 to extract a flow shape of the input business flow (S1101). Then, the CPU 30 executes the flow shape processing module 105 to grid-develop the read business flow, thereby forming a grid graph (S1102).

The grid development is carried out in such a manner that an event and an activity are represented as “points”, an event flow is represented by a “line (arrow)”, and a shape of the business flow is converted. Specifically, the flow shape reading module 104 extracts all the activities and event flows from the business flow read from the business flow input device 40. The flow shape processing module 105 converts each activity into a “point”, and connects an event flow connected to each activity as a “line (arrow)” to the “point”. The business flow is grid-developed by an amount equal to the number of branches.

FIG. 9 illustrates a status where the business flow of the estimation business of the embodiment of this invention is grid-developed. The business flow grid-developed in FIG. 9 corresponds to the business flow of the estimation business shown in FIG. 6.

Referring to FIG. 6, objects corresponding to a start event, estimate creation, money amount checking, final estimate decision, estimate sending, and an end event are arranged in order. From the object corresponding to the third from the left, i.e., money amount checking, an arrow directed between objects corresponding to final estimate decision and estimate sending is drawn corresponding to a condition branch.

For the business flow of the estimation business shown in FIG. 6, by representing the objects as “points” and interconnecting by arrows, a grid graph shown in FIG. 9 can be extracted.

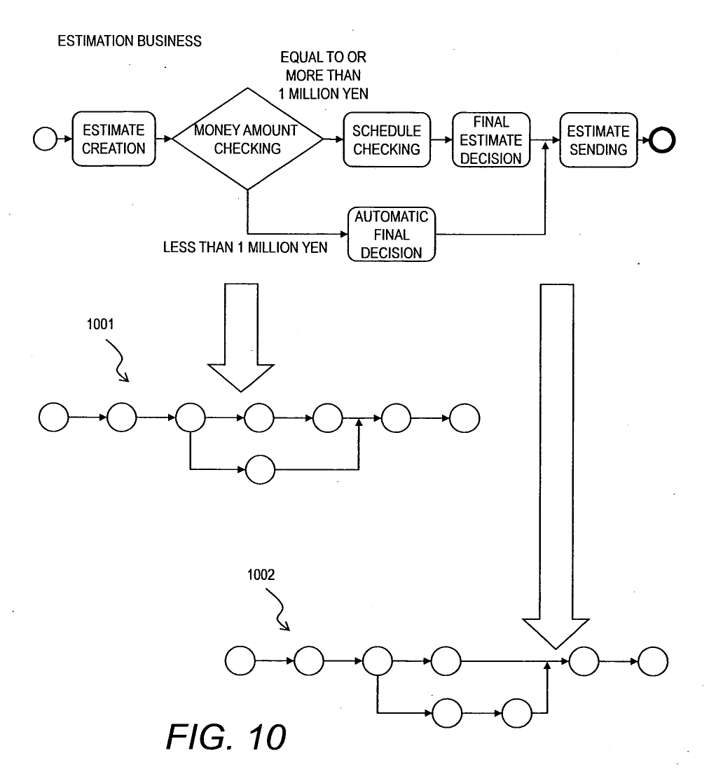

As another example, a business flow different from the business flow of the estimation business shown in FIG. 6 is shown in FIG. 10.

FIG. 10 illustrates a modified example of the business flow of the estimation business of the embodiment of this invention, and a result of grid-developing the modified example. The business flow of FIG. 10 is different from that shown in FIG. 6 in that a schedule of final decision is checked when costs are equal to or more than 1 million yen in money amount checking, final decision is then made, and final decision is automatically made when costs are less than 1 million yen.

In the business flow shown in FIG. 10, the number of businesses is different from condition branching to flow merging. Accordingly, when grid-developed, two types of grid graphs, i.e., a flow shape 1001 and a flow shape 1002, can be obtained.

The flow shape 1001 is a case where the business flow shown in FIG. 10 is directly grid-developed. The flow shape 1002 is a case where a condition branch of the business flow shown in FIG. 10 is replaced.

Thus, by the condition branch, a plurality of flow shapes may be extracted from one business flow. In this case, all extractable flow shapes are obtained to execute a subsequent flow shape information acquisition process.

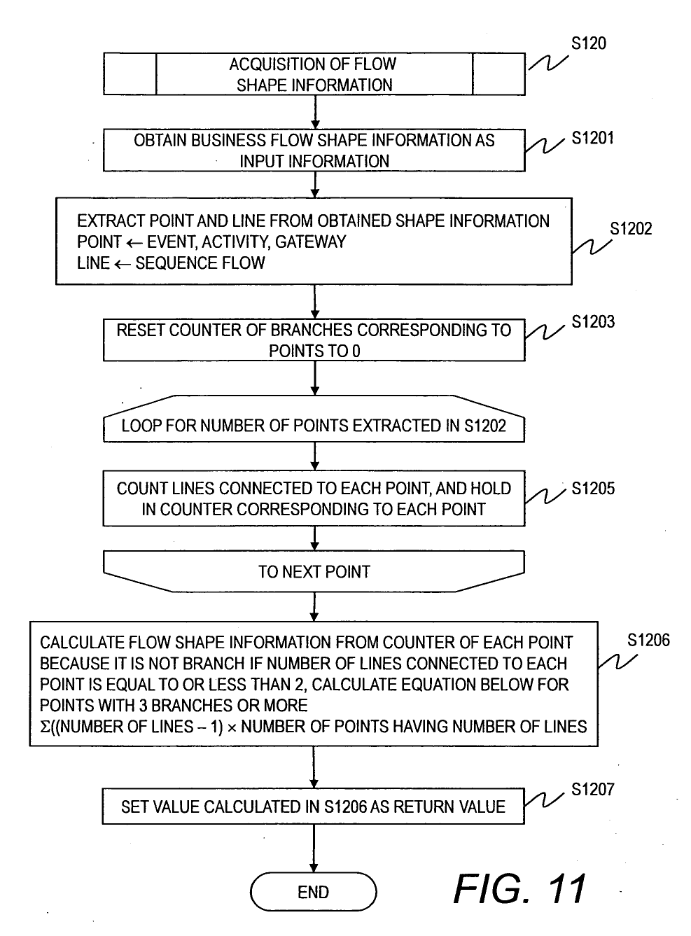

FIG. 11 is a flowchart illustrating a procedure of a flow shape information acquisition process according to the embodiment of this invention. According to the flow shape information acquisition process, a flow shape of a business flow is input to an evaluation equation to calculate a numerical value. Through this process, an evaluation equation is created based on a branching process. The process will be described below in detail.

The CPU 30 first obtains shape information of a business flow as input information (S1201), and extracts “points” and “lines (arrows)” from the obtained shape information (S1202). As described above, the “points” correspond to an event, an activity, and a gateway, while the “lines” correspond to sequence flows.

Subsequently, the CPU 30 resets a counter for storing the number of lines corresponding to points and connected to the points to 0 (S1203). For all the points obtained in the step S1202, the number of connected lines is stored in each counter (S1205).

Upon storage of values of all the points in the counter, the CPU 30 calculates an evaluation equation to obtain flow shape information (S1206). According to the embodiment of this invention, a total of (number of connected lines −1) targeting points having three or more connected lines is set as a value of the evaluation equation of the flow shape information. When points correspond to activities, the number of connected lines is 2 because preceding and succeeding activities are connected. The points having three or more connected lines are points corresponding to a gateway, in other words, a condition branch.

Thus, a value of the evaluation equation of the flow shape information is large when the number of points corresponding to the condition branch is large, and when the number of branches for each condition branch is large. The value of the evaluation equation is affected by the number of points corresponding to the condition branch, but not affected by the number of activities. Accordingly, flow shape information becomes an index indicating not the number of business tasks constituting a business flow but expansion such as process branching.

Lastly, the CPU 30 sets the calculated value of the flow shape information as a return value of the process (S1207) to finish the process.

By using the business flow of the estimation business shown in FIG. 6, a value of flow shape information is actually calculated. Referring to FIG. 9 which shows the business flow of the estimation business represented as a grid, the numbers of lines are 1, 2, 3, 2, and 1 for a start point, estimate creation, money amount checking, a final estimate decision flow and estimate sending, and an end point, respectively.

Because the number of connected lines is 3 or more, a target of the evaluation equation of the flow shape information is only money amount checking, and a value of the flow shape information is (3−1)×1=2.

Calculation of flow shape information will be described by taking an example of a slightly complex business flow.

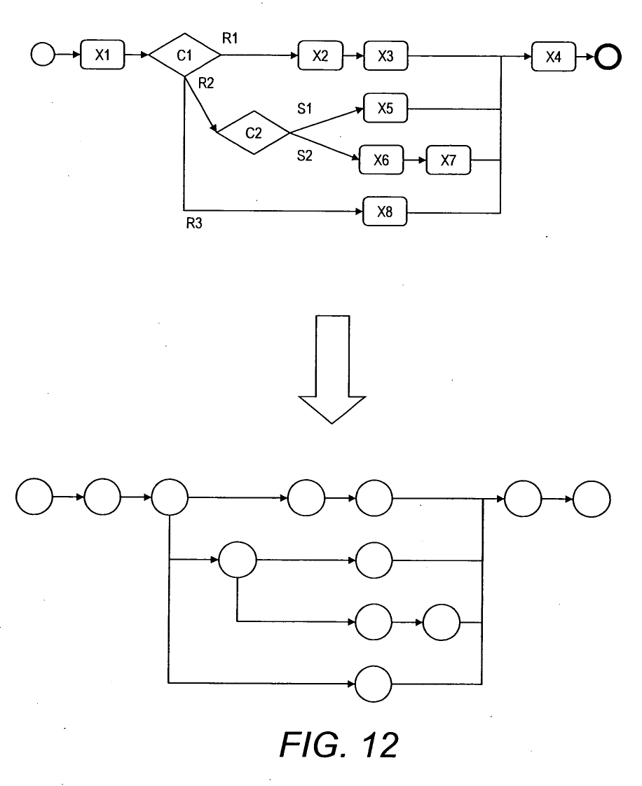

FIG. 12 illustrates an example of a business flow of the embodiment of this invention, and a flow shape represented as a grid. The business flow shown in an upper part of FIG. 12 branches into R1 to R3 at C1, and into S1 and S2 at C2.

Referring to FIG. 12, the numbers of lines are 1, 2, 4, 3, 2, and 1 for a start point, X1, C1, C2, X2 to X8, and an end point, respectively.

Accordingly, the numbers of points are 2, 8, 1, and 1 when the numbers of connected lines are 1, 2, 3, and 4, respectively. When flow shape information is calculated based on the evaluation equation, because points where the number of lines is 3 or more are targets, flow shape information=(3−1)×1+(4−1)×1=5 is established.

Upon completion of the business flow reading process to the flow shape information acquisition process, the business process creation method becomes a procedure of extracting a registered business process similar to the input business flow.

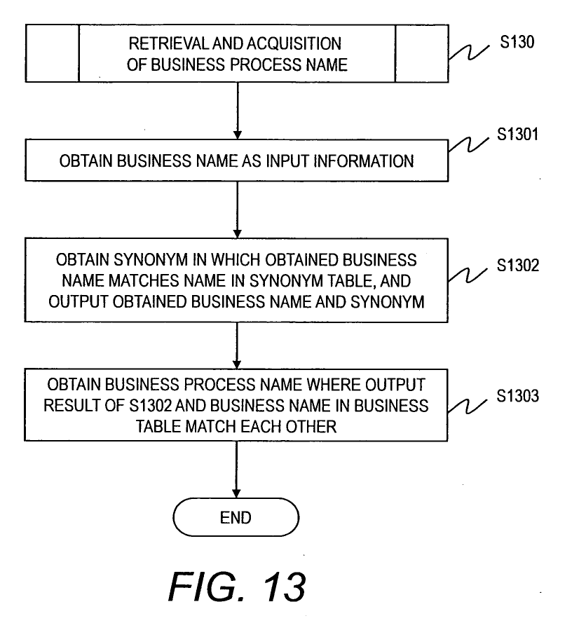

FIG. 13 is a flowchart illustrating a procedure of extracting a business process similar to the input business flow of the embodiment of this invention. According to this process, based on information contained in the input business flow, a business process stored in the past business process resource model management device 154 is extracted.

The CPU 30 first obtains a business name of the extracted business flow as input information (S1301). Subsequently, the CPU 30 refers to the synonym table 157 to obtain a synonym based on the extracted business name of the business flow (S1302).

Based on the synonym obtained in the step S1302, the CPU 30 searches the business table 155 to obtain a business process name (S1303).

Through this process, based on the business name extracted from the input business flow, a synonym that is a similar business name is obtained, and a business process candidate which becomes a creation source of a business process corresponding to the input business flow can be obtained.

FIG. 14 illustrates the synonym table 157 for storing a business name similar to a designated business according to the embodiment of this invention. The synonym table 157 includes a business name 1571 and a synonym 1572.

The business name 1571 becomes a key for extracting a record matched with the input business name. The synonym 1572 stores a business name similar to the business name stored in the business name 1571 as a synonym. The synonym may include a designated business itself.

FIG. 15 illustrates the business table 155 for storing correspondence between a business and a business process according to the embodiment of this invention. The business table 155 includes a business name 1551 and a business process name 1552. The business process name 1552 stores a key for specifying a business process. As shown in FIG. 15, at least one business process corresponds to one business.

A case where a business name of an input business flow is “estimation business” will specifically be discussed. If a business name input in this process is “estimation business”, referring to the synonym table 157 of FIG. 14, “purchase business”, “order placement business”, and “estimation business” are extracted as synonyms. By referring to the business table 155 of FIG. 15 to extract a business process whose business name is “purchase business”, “order placement business”, or “estimation business”, “BPH1”, “BPH2”, “BPH3”, “BPH4”, “BPP1”, and “BPP2” can be obtained.

Accordingly, when “estimation business” is input as a business name, the business processes “BPH1”, “BPH2”, “BPH3”, “BPH4”, “BPP1”, and “BPP2” are extracted.

Then, the input business flow is compared with the extracted business processes to select a business process which becomes a source of a business flow to be created.

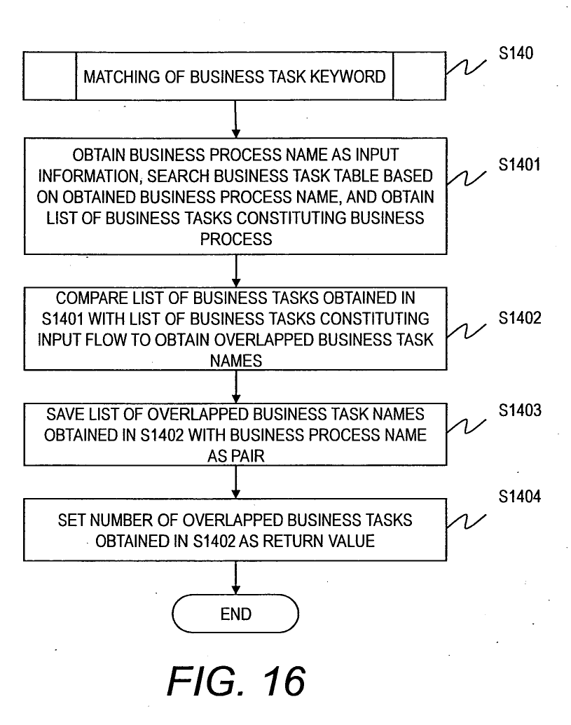

FIG. 16 is a flowchart illustrating a business task matching keyword process for comparing business tasks constituting the input business flow with business tasks constituting the extracted business processes according to the embodiment of this invention. This process is performed for each extracted business process. The process is executed by the business task keyword retrieval module 108.

Before the execution of the process, based on business task names extracted from the input business flow, searching is carried out in the synonym table to obtain synonyms (S131 of FIG. 4). In this case, if overlapped synonyms are extracted, the overlapped portions are removed.

For example, the business flow of the estimation business shown in FIG. 6 includes business tasks whose names are “estimate creation”, “money amount checking”, “final estimate decision”, and “estimate sending”. Referring to the synonym table 157 of FIG. 14, “approval flow” and “in-company flow” are obtained as synonyms of “final estimate decision”. Accordingly, business tasks related to the estimation business are “estimate creation”, “money amount checking”, “final estimate decision”, “estimate sending”, “approval flow”, and “in-company flow”.

Returning to the business task matching keyword process, the CPU 30 first obtains a business process name as input information. Based on the obtained business process name, the CPU 30 searches the business task table 156 to extract a list of business tasks constituting the business process (S1401).

The CPU 30 compares the list of business tasks obtained in the step S1401 with the business task names obtained in the step S131 of FIG. 4 to obtain overlapped business task names (S1402).

The CPU 30 saves the overlapped business task names obtained in the step S1402 with the business process (S1403). Lastly, the number of overlapped business task names is set as a return value of the process (S1404).

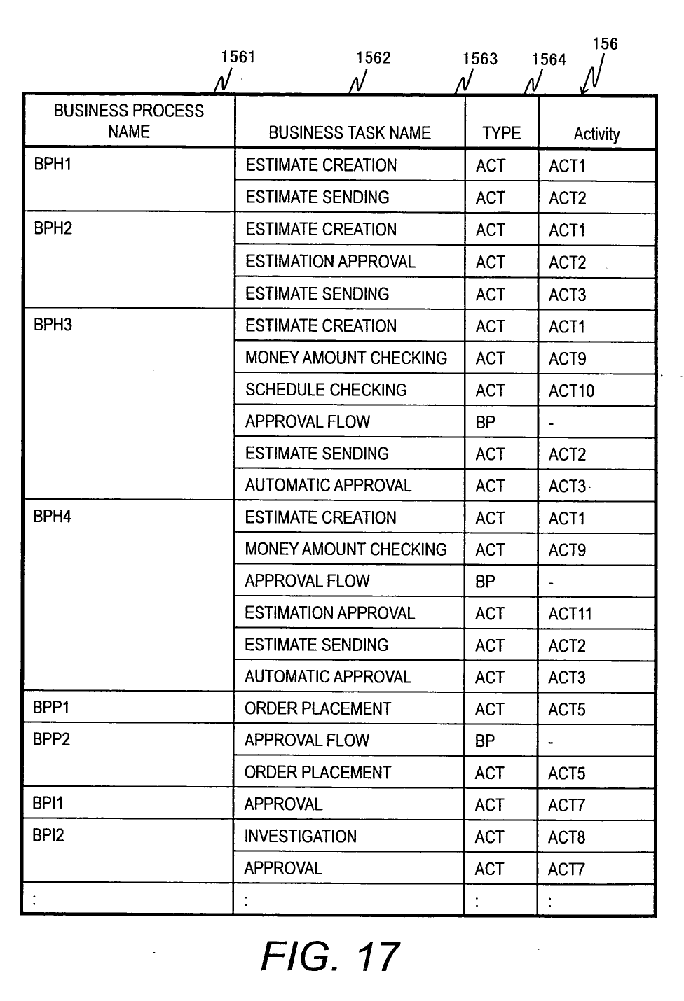

FIG. 17 illustrates the business task table 156 for defining business tasks constituting the business process according to the embodiment of this invention. The business task table 156 includes a business process name 1561, a business task name 1562, a type 1563, and an activity 1564.

The business process name 1561 is used as a key for retrieval, and a business task name constituting a business process is stored in the business task name 1562. The type 1563 indicates a type of a business task. Specifically, if a value is “BP”, a relevant business task constitutes a business, and the business includes at least one business task. If a value is “ACT”, the business includes a single business task, and actual services are loaded. The activity 1564 is an identifier for identifying a business task.

Specifically, the business task names obtained in the step S131 of FIG. 4 are compared with the business task table 156 shown in FIG. 17. The business process “BPH1” includes business tasks “estimate creation” and “estimate sending” which are both included in the business tasks constituting the input business flow. Thus, a return value is 2. Similarly, return values are 2, 4, 4, 0 and 1 for the business processes “BPH2”, “BPH3”, “BPH4”, “BPP1”, and “BPP2”, respectively.

Subsequently, a flow shape of the business process stored in the past business process resource model management device 154 is compared with a flow shape of the input business flow. Because the stored information of the business process contains execution information of a program, the information has to be converted into a format to be compared with the input business flow. This conversion work is called a flow shape normalization process.

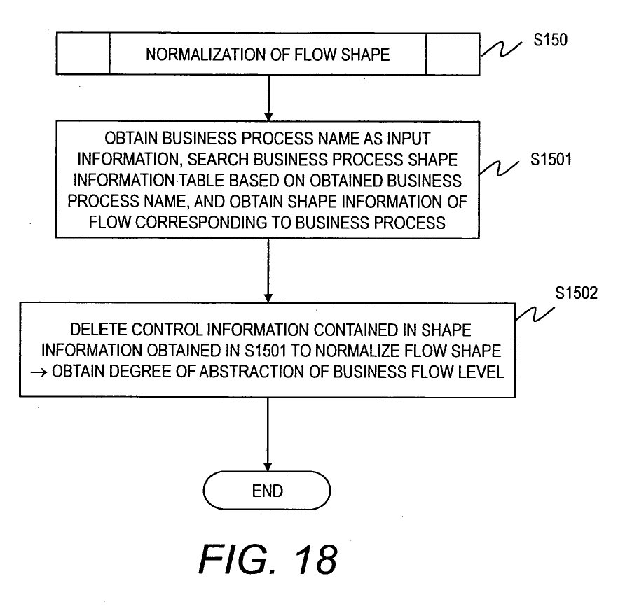

FIG. 18 is a flowchart illustrating the process of normalizing the flow shape according to this invention. This process is carried out by the flow shape normalization module 109.

The CPU 30 first obtains a business process name as input information. Based on the obtained business process name, the CPU 30 searches the business process shape information table 158 to obtain flow shape information corresponding to the business process (S1501).

The CPU 30 deletes control information contained in the obtained flow shape information to normalize a flow shape (S1502). The control information is, for example, a variable assign process or a data conversion process, i.e., a process not dependent on a business but a process necessary for executing a program.

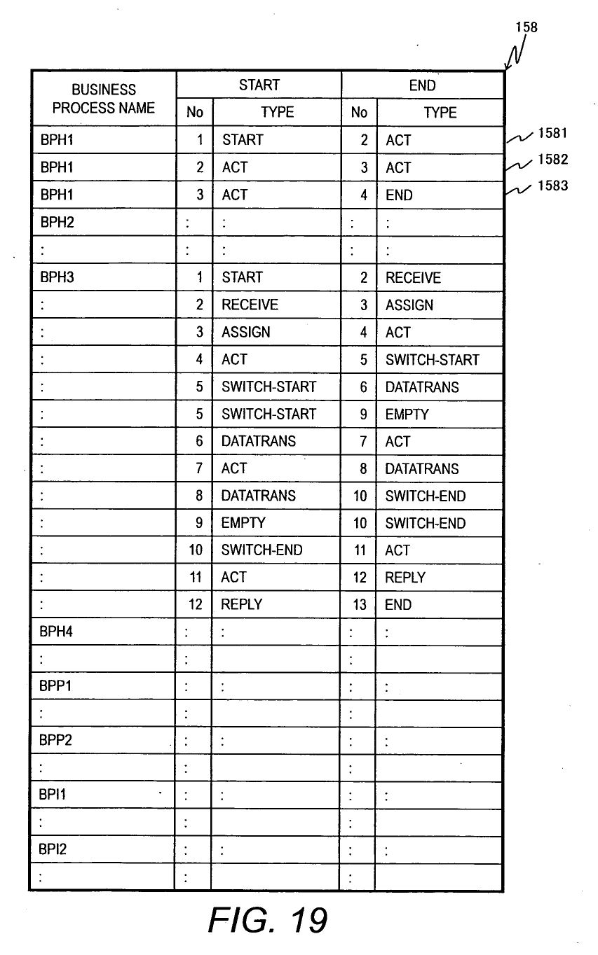

FIG. 19 illustrates the business process shape information table 158 according to the embodiment of this invention.

The business process shape information table 158 includes a business process name and pieces of information on start and end points. The information of the start point contains the number for identifying a “point” and a type of a business task indicated by the “point”. A flow always starts from “1”, and ends at a “point” to which the number of a maximum value is added.

The type includes “Start” indicating a start of the flow, “END” indicating an end of the flow, and “ACT” indicating a normal business task. “SWITCH-START” indicating branching, and “SWITCH-END” indicating an end of the branching are included, and types of parts constituting BPEL are stored.

Referring to FIG. 19, a case where a business process name is “BPH1” will be described. Referring to records 1581 to 1583, a point having No of “2” follows a point having No of “1”, a point having No of “3” follows the point having No of “2”, and a point having No of “4” follows the point having No of “3”. Accordingly, the “BPH1” includes start and end points and two business tasks, forming a flow shape where the two business tasks are carried out in order.

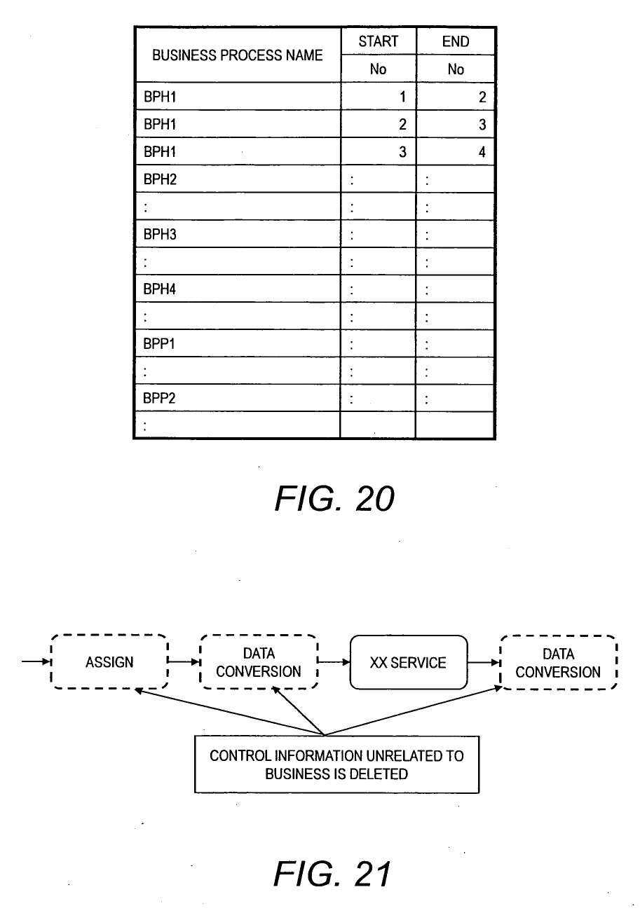

FIG. 20 illustrates a modified example of the business process shape information table 158 according to the embodiment of this invention.

If information of a business flow level not containing control information has been stored, as shown in FIG. 20, only No's of a start and an end are stored without needing any types. In the case of the information of the business flow level, because an end of branching is not related to a “point”, an intermediate part between a “point” and a “point” is indicated. In this case, for example, as in the case of No of “point”-No of “point”, the intermediate part is represented by “2-3”. “2-3” indicates presence of an end point between a point of No “2” and a point of No “3”.

Upon acquisition of the flow shape from the business process shape information table 158, the business process creation method normalizes the obtained flow shape. According to the embodiment of this invention, the business process shape information table 158 shown in FIG. 19 is used.

FIG. 21 illustrates deletion of an activity indicating control information according to the embodiment of this invention. An activity indicated by a dotted line is control information. As shown in FIG. 21, control information not directly related to a business itself such as “assign” or “data conversion” is deleted.

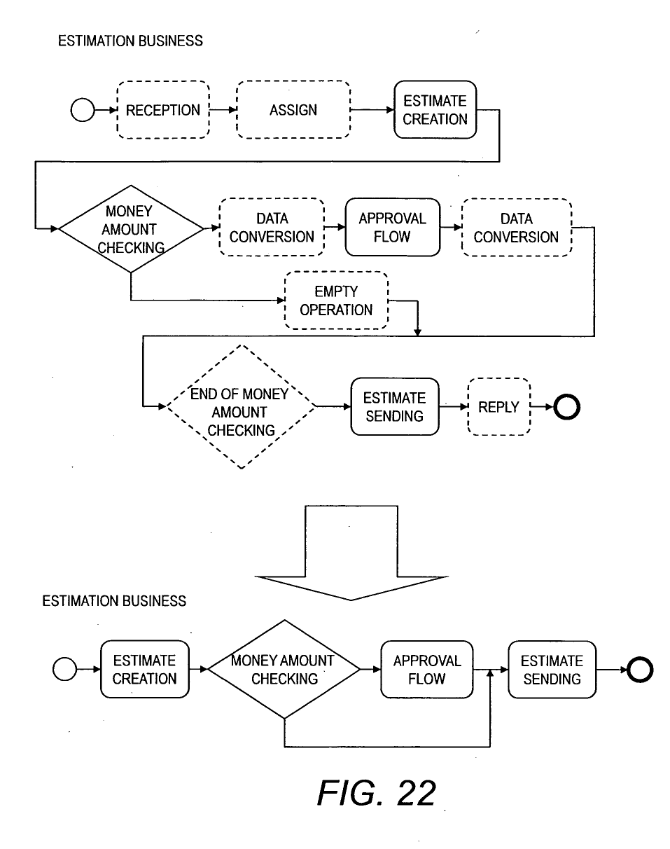

FIG. 22 illustrates a flow shape obtained from the business process shape information table 158 and a normalized flow shape according to the embodiment of this invention.

An upper part of the drawing shows a flow shape where a business process name “BPH3” of the business process shape information table 158 shown in FIG. 19 is represented by BPMN. A lower part of the drawing shows a normalized flow shape.

Referring to FIG. 19 and FIG. 22, a procedure of normalizing the flow shape obtained from the business process shape information table 158 will be described.

“START” of “No 1” that is an event is left in the flow after normalization. “RECEIVE” of “No 2” is deleted because it is control information. Because an activity of “No 2” is connected to “No 3”, information connected to “No 2” is connected to the “No 3”. Accordingly, the “No 1” is connected to the “No 3”.

“ASSIGN” of “No 3” is deleted because it is control information. Because the activity of “No 3” is connected to “No 4”, the “No 1” is connected to the “No 4”.

“ACT” of “No 4” is left as it is because it is a business task. “SWITCH-START” of “No 5” is left as it is because it is a branch.

“DATATRANS” of “No 6” is deleted because it is control information. Because the activity of “No 6” is connected to “No 7”, the “No 5” is connected to the “No 7”.

“ACT” of “No 7” is left as it is because it is a business task. “DATATRANS” of “No 8” is deleted because it is control information. Because the activity of “No 8” is connected to “No 10”, the “No 7” is connected to the “No 10”.

“EMPTY” of “No 9” is deleted because it is control information. Because the activity of “No 9” is connected to “No 10”, the “No 5” is connected to the “No 10”.

“SWITCH-END” of “No 10” is deleted because it is control information. Because the activity of “No 10” is connected to “No 11”, the “No 5” is connected to the “No 11”. The “No 7” is similarly connected to the “No 10”. However, the “No 7” is connected on a line of the “No 5” and the “No 11” because it has been corrected to the “No 11”.

“ACT” of “No 11” is left as it is because it is a business task. “REPLY” of “No 12” is deleted because it is control information. Because the activity of “No 11” is connected to “No 12”, the “No 11” is connected to the “No 13”.

Through this process, the normalized business flow shown in the lower part of FIG. 22 can be obtained.

Subsequently, according to the business process creation method, the flow shape corresponding to the normalized business process is compared with the input business flow.

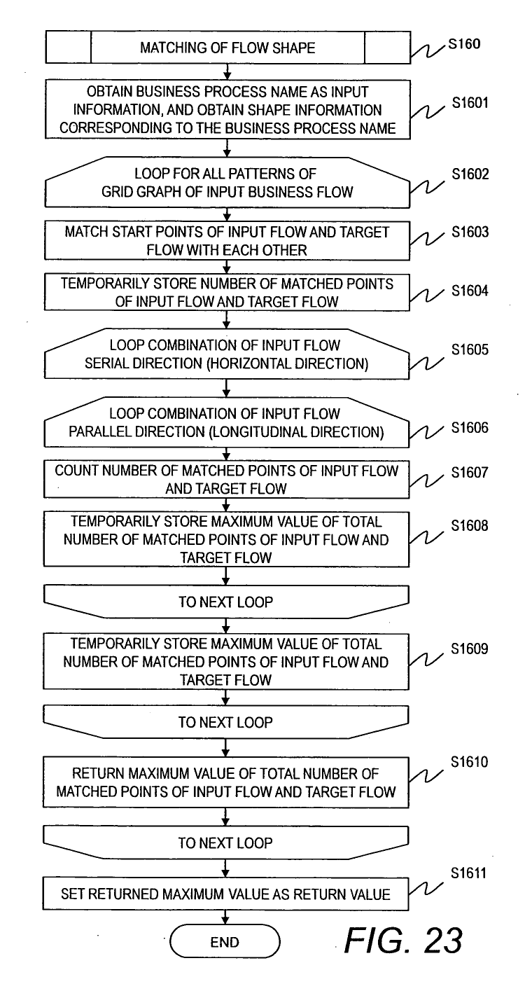

FIG. 23 is a flowchart illustrating the process of comparing the flow shape of the business flow according to the embodiment of this invention. This process is carried out by the flow shape matching module 110.

The CPU 30 first obtains a business process name as input information and the flow shape corresponding to the business process name normalized in the step S150 as comparison target flow (S1601).

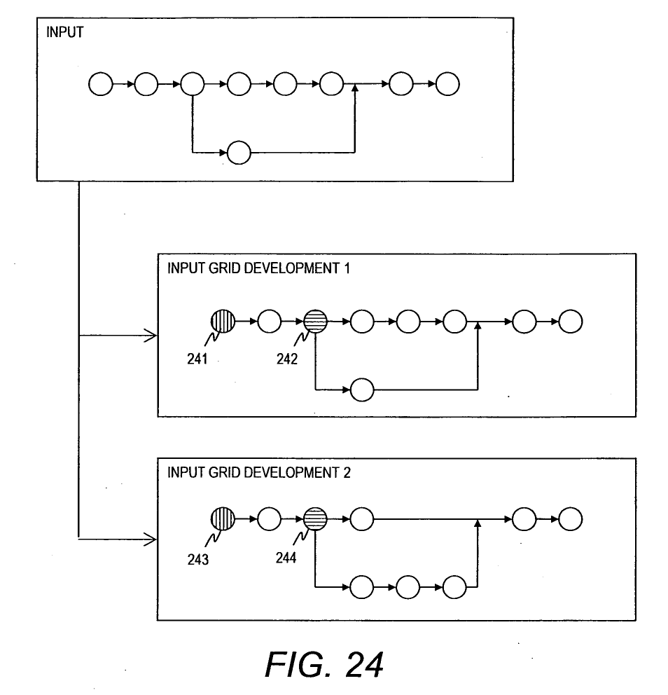

The flow shape of the input business flow formed into a grid graph is subjected to the following processing for all the patterns. All the patterns of the flow shape of the input business flow formed into the grid graph is, for example, as shown in FIG. 24.

FIG. 24 illustrates an example of an input business flow of a flow shape according to the embodiment of this invention. When an uppermost part of the drawing shows an input business flow, two types of grid graphs, i.e., input grid development 1 and input grid development 2, can be obtained. Thus, when grid graphs of a plurality of patterns are obtained, each is compared with a comparison target flow.

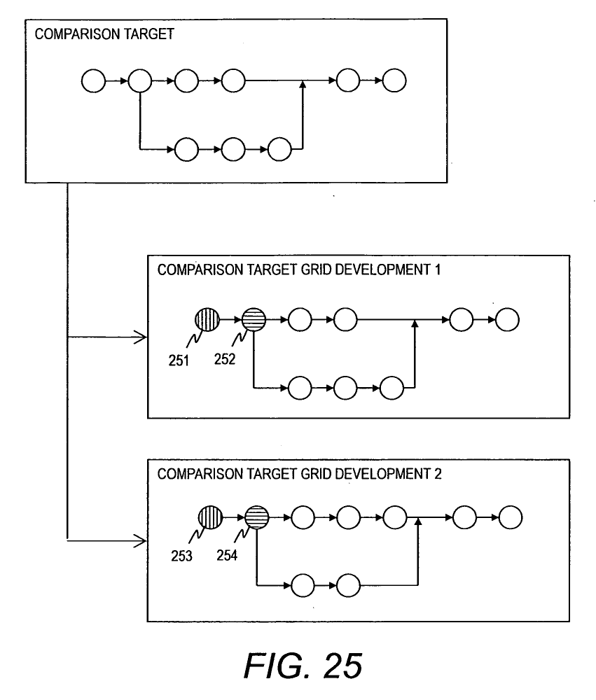

The same applies to the comparison target flow. An example is shown in FIG. 25.

FIG. 25 illustrates an example of a flow shape compared with the input business flow of the flow shape according to the embodiment of this invention. When an uppermost part of the drawing shows a comparison target flow, similarly, comparison target grid development 1 and comparison target grid development 2 are compared with the input business flow.

A procedure of comparing the flow shapes will specifically be described below.

The CPU 30 first obtains a business process name as input information and a flow shape corresponding to the business process (S1601).

Subsequently, the CPU 30 executes the following processing for the flow shape of the input business flow formed into a grid graph (S1602).

The CPU 30 matches two start points of two flows to be compared with each other (S1603). For example, a start point 241 of the input grid development 1 of FIG. 24 and a start point 251 of the comparison target grid development 1 of FIG. 25 are matched with each other. When the input grid development 1 and the comparison target grid development 2 are combined, 7 points match one another. This value is stored as an initial value (S1604).

Subsequently, the CPU 30 matches branch points of the two flows to be compared with each other (loop of S1605). For example, a branch point 242 of the input grid development 1 and a branch point 252 of the comparison target grid development 1 are matched with each other. In this case, the number of matched points from the start point to the branch point is 2. If the numbers of branches are different at the matched branch points, for all combinations (loop of S1606), the input flow and the target flow are compared with each other, the number of matched points is counted, and a maximum value is stored (S1608). When the input grid development 1 is compared with the comparison target grid development 1 and the comparison target grid development 2, the number of matched points is 2+1 in the case of the input grid development 1 and the comparison target grid development 1, and the number of matched points is 3+1 in the case of the input grid development 1 and the comparison target grid development 2. Thus, a maximum value of matched points is 4, and this value is stored in the step S1608.

For all the branches, the number of matched points is counted, and a largest pattern is selected. The remaining points of the flow are compared to calculate a maximum value of the number of matched points (S1609). Referring to FIGS. 24 and 25, the number of matched points of the comparison target grid development 2 with respect to the input grid development 1 is 8 which is maximum.

Comparison is similarly made for the input grid development 2 in the loop of the step S1602, and a maximum value of the number of matched points is lastly set as a return value of the process (S1611).

According to the embodiment of this invention, for the business process names extracted in the step S130 of FIG. 4, the flow shapes are actually compared by using the business flow shown in FIG. 6 as an input flow.

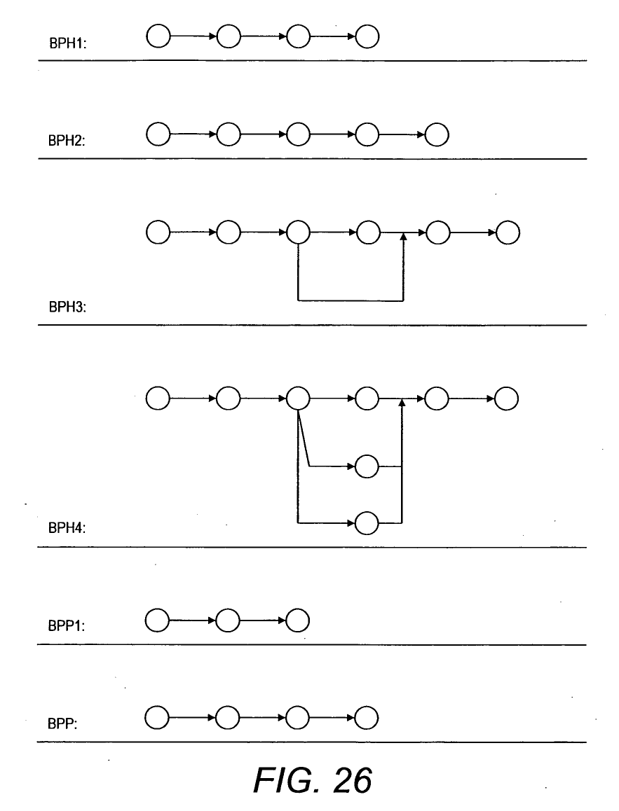

FIG. 26 illustrates a list of flow shapes corresponding to business process names similar to the input business flow according to the embodiment of this invention.

When a process of a flow shape of each business process shown in FIG. 26 and a process actually shown by the flowchart of FIG. 23 are executed for the input flow of FIG. 9 which is a grid graph of the business flow shown in FIG. 6, values of 4, 5, 6, 6, 3 and 4 can be obtained for “BPH1”, “BPH2”, “BPH3”, “BPH4”, “BPP1”, and “BPP2”, respectively.

Flow shape information of flow shape converted into numerical values will be described. The flow shape information indicates a numerical value of a shape of a business flow formed into a grid graph. Pieces of flow shape information are compared with each other to obtain similarity.

Specifically, targeting points where the number of connected lines is 3 or more, the number of lines extended from one point is counted, and the number of lines is multiplied by the number of points to be added together. A point where the number of connected lines is 3 or more corresponds to a branch point. Thus, the number of branch points and the number of branches at each branch point are more similar, similarity is greater. A procedure of calculating the flow shape information has been described referring to the step S1206 of FIG. 11.

Then, for the input business flow and the business process of a comparison target, pieces of flow shape information thereof are calculated to obtain a difference. Since values are more approximate when the input business flow and the business process of the comparison target are more similar, flow shapes are more similar when the obtained difference is smaller. When a difference is calculated, if a numerical value of the comparison flow is larger than that of the input flow, the obtained difference is multiplied by a coefficient of 0.5. It is because in terms of similarity, flow shapes are more likely to be similar when the number of branch points is larger than when the number thereof is smaller.

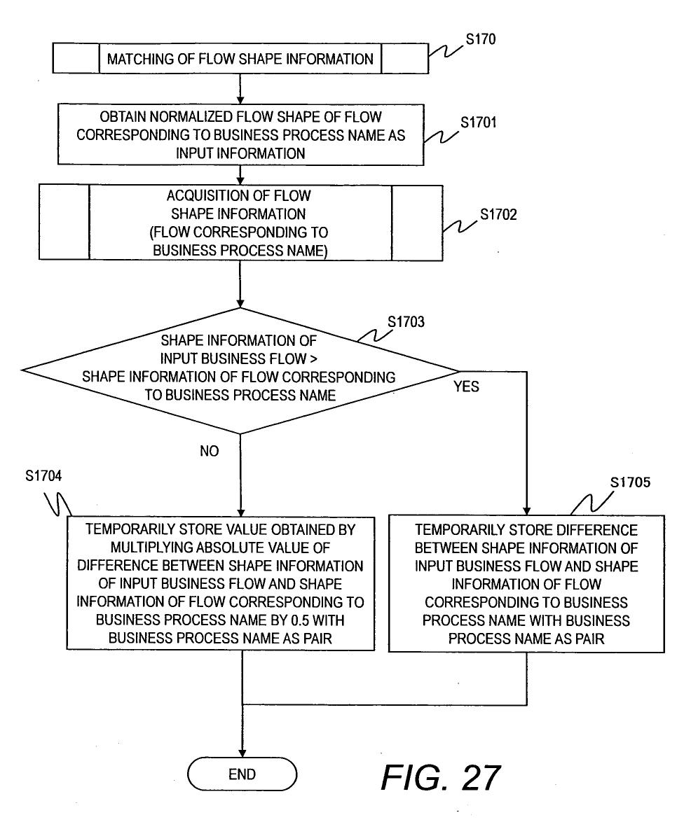

FIG. 27 is a flowchart illustrating a matching process of pieces of flow shape information according to the embodiment of this invention.

The CPU 30 first obtains a normalized flow shape of a flow corresponding to a business process name as input information (S1701). For the input flow shape, the flow shape information acquisition process shown in FIG. 11 is carried out to obtain flow shape information (S1702).

The CPU 30 judges whether a value of flow shape information of the comparison flow is larger than that of the flow shape information of the input business flow (S1703). If the value of the flow shape information of the comparison flow is larger than that of the flow shape information of the input business flow (result of S1703 is “YES”), an obtained difference is multiplied by a coefficient of 0.5.

Thus, the obtained difference is stored as flow shape information in the main memory 31 (S1704 and S1705).

According to the embodiment of this invention, pieces of flow shape information are specifically calculated for business processes to obtain a difference in flow shape information. When flow shape information of the input business flow is calculated, in the step S120, a value “2” is obtained for the input business flow.

Values of pieces of flow shape information of the extracted business processes are respectively 0 for “BPH1” and “BPH2”, 2 for “BPH3”, 3 for “BPH4”, and 0 for “BPP1” and “BPP2”. When differences from the input business flow are obtained, those for “BPH1”, “BPH2”, “BPP1”, and “BPP2” are 2. A difference for “BPH3” is 0, and a difference for “BPH4” is 3−2=1. Because the value of the flow shape information of the comparison flow is larger than that of the flow shape information of the input business flow, 1×0.5=0.5 is set.

Subsequently, similarity between branch conditions of the input business flow and branch conditions of a similar business process is judged.

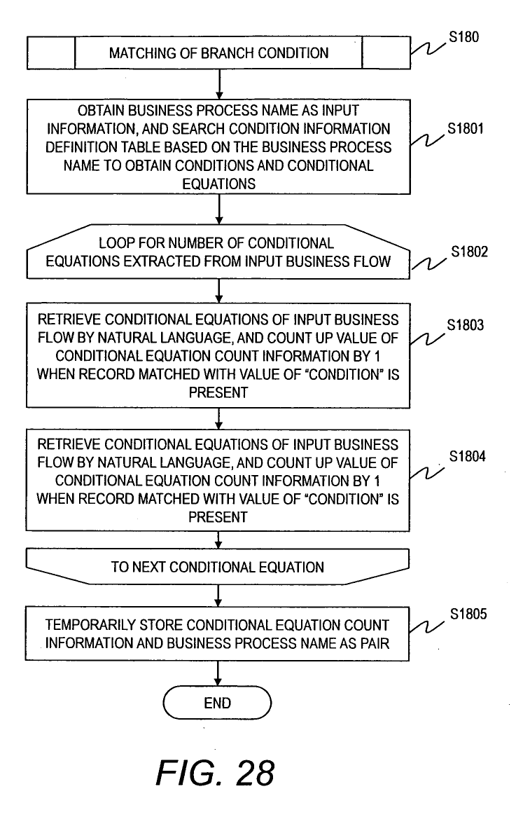

FIG. 28 is a flowchart illustrating a procedure of judging similarity of branch conditions between business flows according to the embodiment of this invention. This process is executed by the condition information matching module 118.

The CPU 30 first obtains a business process name as input information, and searches the condition information definition table 162 based on the obtained business process name to obtain branch conditions and a conditional equation (S1801).

The CPU 30 executes the following process for all conditional equations contained in the input business flow (loop of S1802).

The CPU 30 retrieves conditional equations by natural language, and adds a value of conditional equation count information if records matching values of condition fields of the condition information definition table 162 are present (S1803).

The CPU 30 retrieves conditional equations by natural language, and adds a value of conditional equation count information if records matching values of condition value fields of the condition information definition table 162 are present (S1804).

The CPU 30 searches the condition information definition table 162 for all conditional equations contained in the input business flow, and stores, upon acquisition of conditional equation count information, the conditional equation count information and a business process name as a pair in the main memory (S1805).

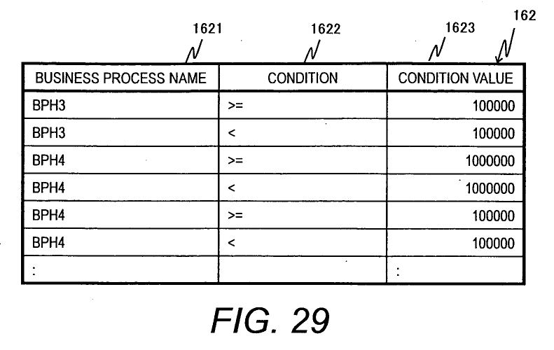

FIG. 29 illustrates the condition information definition table 162 according to the embodiment of this invention. The condition information definition table 162 is stored in the past business process resource model management device 154 of the external storage system 2. The condition information definition table 162 stores branch conditions contained in the business process. The condition information definition table 162 includes a business process name 1621, a condition 1622, and a condition value 1623.

The condition 1622 stores conditions contained in a business process designated in the business process name 1621. For example, an inequality sign is stored to designate a boundary of a numerical value range. The condition value 1623 stores a value for specifying a boundary value of the condition 1622. For example, a numerical value is stored. The value is not limited to a numerical value. Any value may be used as long as it specifies a branch condition. For example, in the case of 100 or more, “>=” is stored in the condition 1622, and “100” is stored in the condition value 1623.

Referring to the condition information definition table 162 shown in FIG. 29, similarity of branch conditions is judged between the business flow shown in FIG. 6 and each business process.

In the business flow of FIG. 6, the activity of money amount checking branches into 1 million yen or more (>=1,000,000) or less than 1 million yen (<1,000,000). For the extracted business processes “BPH1”, “BPH2”, “BPH3”, “BPH4”, “BPP1”, and “BPP2”, because no branch conditions are included in the business processes “BPH1”, “BPH2”, “BPP1”, and “BPP2”, conditional equation count information becomes 0.

For the business process “BPH3”, “or more” and “less than” are extracted from “1 million yen or more and “less than 1 million yen”, and “>=” and “<” of the condition 1622 match. Accordingly, conditional equation count information becomes 2.

For the business process “BPH4”, as in the case of the business process “BPH3”, “or more” and “less than” are extracted from “1 million yen or more” and “less than 1 million yen”, and “>=” and “<” of the conditions 1622 match. Because “1,000,000” and “1,000,000” of the condition value 1623 match, conditional equation count information becomes 4.

Through this process, similarity of business tasks, similarity of flow shapes, similarity of pieces of flow shape information, and similarity of branch conditions between the input business flow and the retrieved business process are calculated. Then, based on results of the calculation, the similarity calculation results are displayed to assist the user to select a business process which becomes a source of a new business flow to be created.

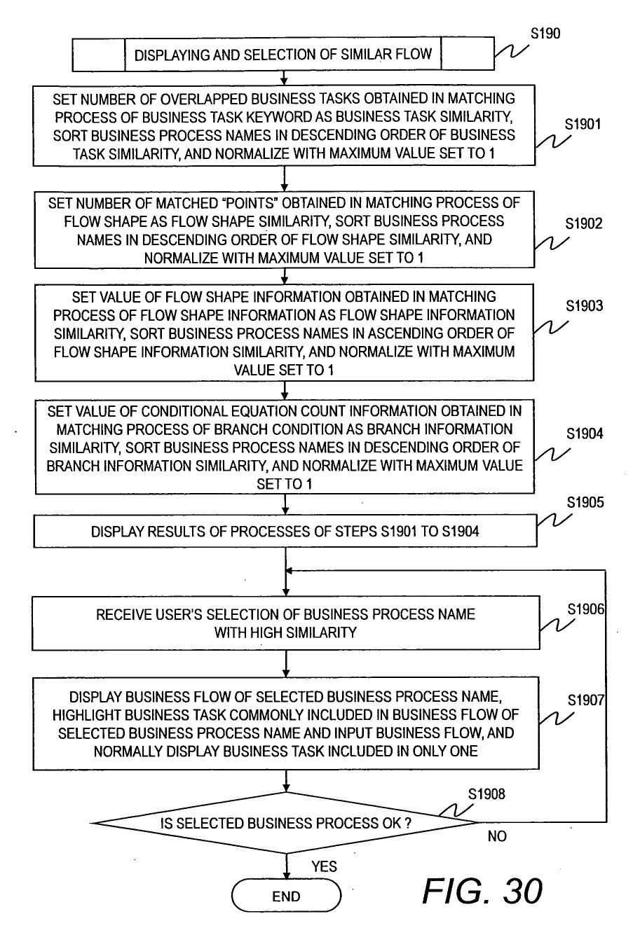

FIG. 30 is a flowchart illustrating a procedure of displaying and selecting business processes similar to the input business flow according to the embodiment of this invention. This process is carried out by the sorting module 112, the similar flow display module 113, and the similar flow deciding module 114.

According to this process, first, to combine and compare the similarities calculated based on viewpoints, calculation results are normalized to be included within a range of 0 to 1. Then, the normalized results are displayed to receive selection of business process names.

The CPU 30 sets the number of overlapped business tasks obtained in the step S140 as a business task similarity, sorts the business process names in descending order of business task similarities, and normalizes the business process names so that a maximum value can be 1 (S1901).

The CPU 30 sets the value of the flow shape information obtained in the step S160 as flow shape information similarity, sorts the business process names in ascending order of flow shape information similarities, and normalizes the business process names so that a minimum value can be 1 (S1902).

For the flow shape similarities obtained in the step S170, the CPU 30 sorts the business process names in descending order of flow shape similarities, and normalizes the business process names so that a maximum value can be 1 (S1903).

For the branch information similarities obtained in the step S180, the CPU 30 sorts the business process names in descending order of branch information similarities, and normalizes the business process names so that a maximum value can be 1 (S1904).

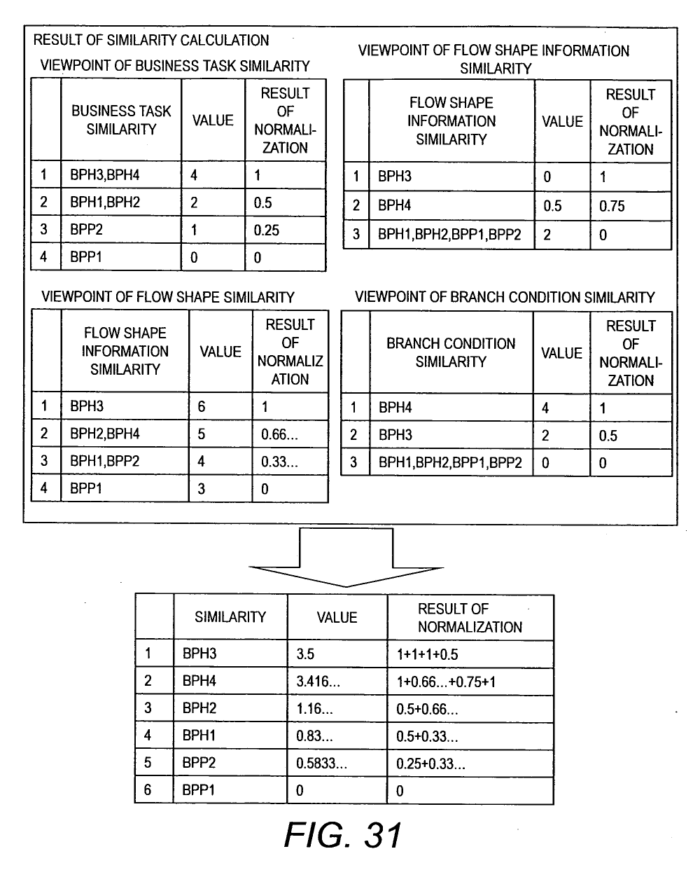

FIG. 31 illustrates a result of normalizing the similarity from each viewpoint of the business process name similar to the input business flow according to the embodiment of this invention.

An upper part of the drawing shows the similarities of viewpoints calculated through the aforementioned process and the results of normalization. For example, in the viewpoint of the business task similarity, values of the business processes “BPH3” and “BPH4” are 4 at maximum. Accordingly, by dividing each value with 4, the similarities are normalized so that values of all the similarities can be included within a range of 1 to 0.

Normalization is similarly carried out for the other viewpoints. However, for the flow shape information similarity, similarity is higher when a value is smaller while similarities of the other viewpoints are higher when values are larger. Thus, the similarity is normalized by dividing each value with a maximum value (2 in this case), and subtracting the obtained value from 1.

If a minimum value is not 0 as in the case of the viewpoint of the flow shape similarity, the similarity is normalized after the minimum value is adjusted to be 0. Specifically, in the viewpoint of the flow shape similarity of FIG. 31, since a minimum value is 3, 3 is subtracted from all values, and the values are divided by a maximum value 3 (=6−3) after the subtraction to obtain a result of normalization.

A lower part of the drawing shows a table where similarities calculated from the viewpoints are totaled, and the similarities are sorted in ascending order of total values. In the table of the lower part of FIG. 31, a result of totaling normalized values of similarities of the viewpoints is set as a value. Referring to the table of the lower part of FIG. 31, the business process “BPH3” is “3.5”, which is a maximum value.

The flowchart of FIG. 30 will be described again.

Upon normalization of the similarities of the viewpoints, the CPU 30 displays the results or normalization (S1905). Then, for example, the CPU 30 displays the results of normalization together with the entire FIG. 31 or the table of the lower part of FIG. 31 to receive selection of a business process judged to be highly similar by the user (S1906).

Upon reception of selection of the business process, the CPU 30 displays a business flow of the selected business process name (S1907). Then, the CPU 30, for example, highlights business tasks commonly included in the business flow of the selected business process name and in the input business flow to display business tasks discriminated from business tasks included in one.

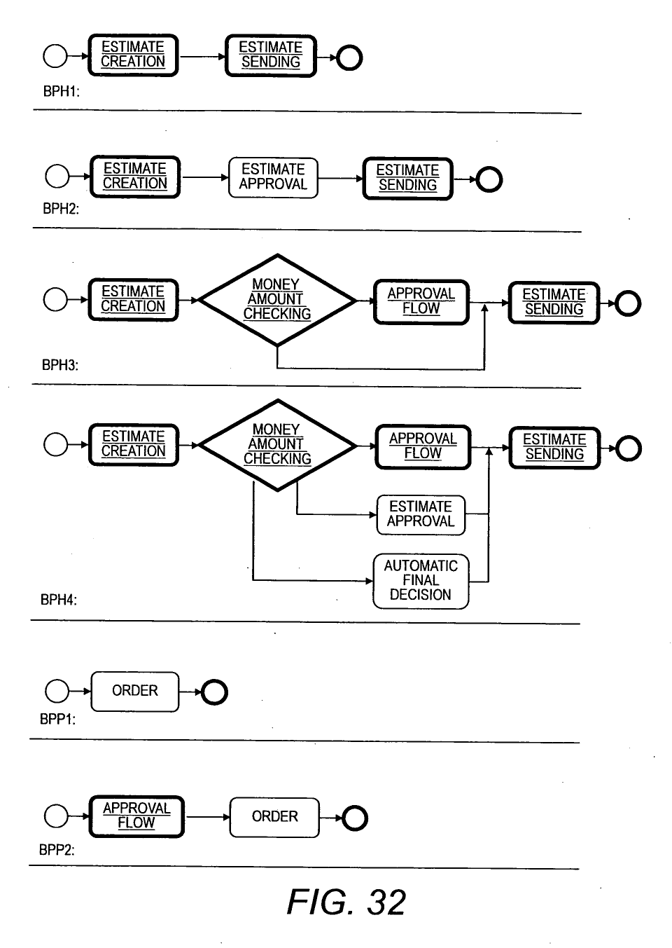

FIG. 32 illustrates a business flow of a business process where business tasks common to the input business flow according to the embodiment of this invention are discriminated to be displayed. FIG. 32 illustrates business flows of all retrieved business processes. For each activity, common business tasks are indicated by heavy line frames and underlines.

The example of FIG. 32 is only an example. Any method of discriminatory displaying can be employed. For example, if color displaying is enabled, common business tasks may be displayed by changing colors.

Upon displaying of the business flow of the selected business process, the CPU 30 receives confirmation of the user (S1908). If the selected business process is acceptable (result of S1908 is “YES”), the process is finished. If another business process is selected again (result of S1908 is “NO”), the process returns to the step S1906.

The normalized result is displayed, and the business flow is displayed after the business process is selected. However, a business flow whose common part has been highlighted in advance within a displayable range may be displayed with a normalized result.

Subsequently, according to the business process creation method, an executable format is output based on the selected business process. Thus, based on the selected business process, a conversion process necessary for outputting the executable format of the input business flow is carried out.

Description of the embodiment of this invention will be continued below presuming that the business process “BPH3” has been selected.

Upon completion of the business process selection, the CPU 30 checks whether a business task name constituting the business process matches a business task name constituting the input business flow. When a synonym of the business task name constituting the business process matches the business task name constituting the input business flow, if the business task name of the input business flow is different from the business task name stored in the business task table 156, a business task name of the BPEL to be output may deviate. Accordingly, the business task name constituting the business process is changed to the business task name constituting the input business flow (S191 of FIG. 5). This process is carried out by the automatic flow correction module 115.

According to the embodiment of this invention, the business task “final estimate decision” included in the input business flow is a synonym of the business task “approval flow” of the selected business process “BPH3”. Thus, the business task “approval flow” of the business process “BPH3” is changed to “final estimation decision”.

For the business task included in the input business flow, if the type 1563 is “BP” and includes a business task (result of S192 of FIG. 5 is “YES”), the CPU 30 recursively executes the process of the step S130 and after by using the business task as a business name (S192 of FIG. 5).

Upon completion of the recursively executed process, because data formats to be input and to be output in businesses of the calling source and destination are different, a data conversion process has to be added. Referring to the business flow of FIG. 6, the business of the calling source corresponds to “estimation business”, and the business of the calling destination is a business executed from “estimation business” as in the case of “final estimate decision” and including a plurality of business tasks as shown in FIG. 7.

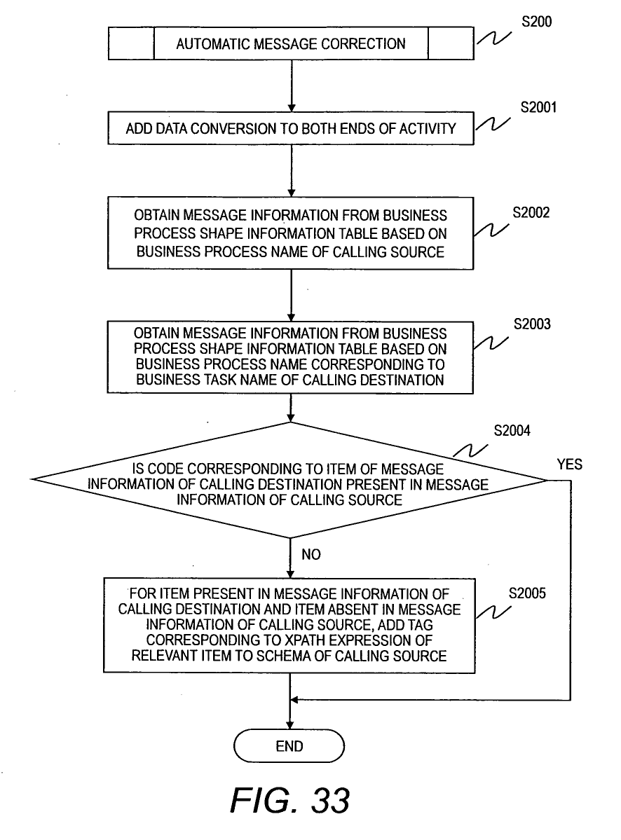

FIG. 33 is a flowchart showing an automatic message format correction process according to the embodiment of this invention. This process is carried out by the automatic message format correction module 116.

As described above, if the business task that includes business tasks is included in the business flow, the CPU 30 adds a data conversion process to both ends of an activity corresponding to the business task (S2001). If the business task that includes the business tasks is not included in the business flow, the automatic message format correction process is not executed.

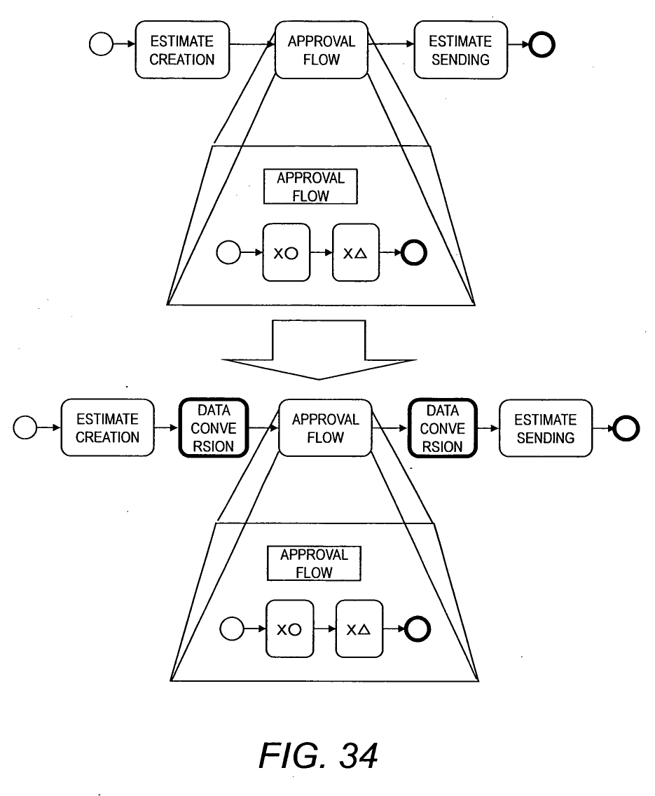

FIG. 34 illustrates a business flow which includes a business task including business tasks according to the embodiment of this invention. An upper part of the drawing shows a business flow before a data conversion process is added. A lower part of the drawing shows a business flow after a data conversion process is added.

The business flow shown in FIG. 34 includes a business task “approval flow” which includes a plurality of business tasks. Accordingly, as shown in the lower part of the drawing, by adding a data conversion process before and after the business task “approval flow”, data I/O formats of the calling source and the calling destination are matched with each other.

Herein, the description will be back to the flowchart of FIG. 33.

The CPU 30 obtains a business process name of the calling source, and message format information from the business process shape information table 158 (S2002). Based on a business process name designated by a business task of the calling destination, the CPU 30 obtains message format information from the business process shape information table 158 (S2003).

The CPU 30 judges whether there are items, among items requested from the calling destination in the message format information obtained in the step S2003, which correspond to the message format information of the business process of the calling source (S2004).

If items requested from the calling destination are not present at the calling source (result of S2004 is “NO”), items of the message format information only included in the calling destination are added to a schema of the calling source (S2005). The process will be described below in detail.

If items requested from the calling destination are all included in the calling source (result of S2004 is “YES”), the CPU 30 refers to the variable definition table 159 to automatically generate data conversion. Because data that become inputs and outputs of the BPEL are all held after codes are added as logical information, the calling source and the calling destination can automatically be correlated.

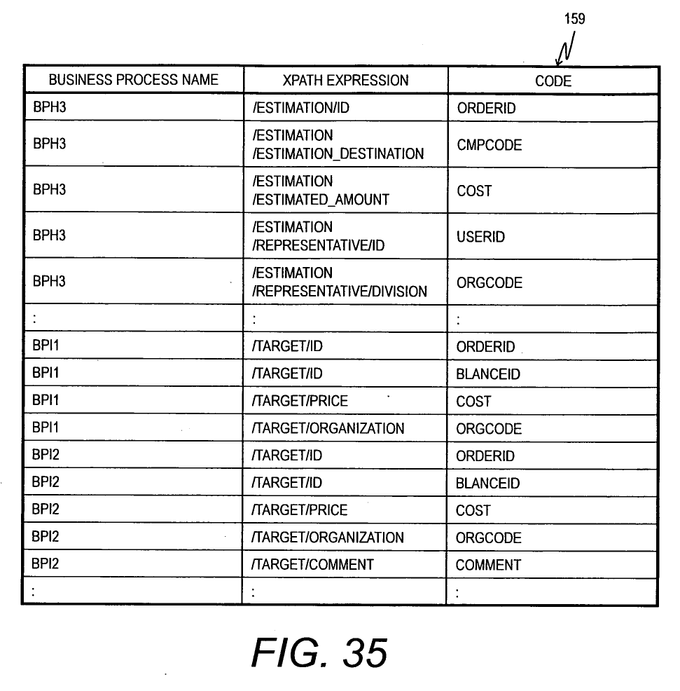

FIG. 35 illustrates an example of the variable definition table 159 according to the embodiment of this invention. The variable definition table 159 includes a business process name 1591, an XPath expression 1592, and a code 1593.

The XPath expression 1592 is an expression for describing a position of data in an XML document. The code 1593 is a code added to data stored in the position designated by the XPath expression 1592.

A plurality of codes may be defined for the same business process and the same XPath expression. In this case, some codes among the plurality of designated codes only need to be set.

The items requested from the calling destination and the items held in the calling source can be judged by referring to the variable definition table 159. Specifically, when a business process of the calling source is designated, a code 1593 in use can be extracted. Because the business process of the calling destination has been designated at the time of executing the automatic message format correction process, the codes 1593 only need to be compared for the business process of the calling destination.

The automatic message format correction process will be described referring to the drawings. According to the embodiment of this invention, as described above, the estimation business of the business process “BPH3” has been selected. The estimation business of the business process “BPH3” includes a business task of an approval flow, which further includes a plurality of business tasks.

For the business task of the approval flow included in the estimation business of the business process “BPH3”, a case of selecting an approval flow of “BPI1” and a case of selecting an approval flow of “BPI2” will be described.

First, the case of selecting the approval flow of the “BPI1” will be described. In the approval flow of the “BPI1”, referring to the variable definition table 159, requested data are “/target/ID”, “/target/price”, and “/target/organization”. On the other hand, the data held by the “BPH3” serving as calling source are “/estimation/ID”, “/estimation/estimation_destination”, “/estimation/estimated amount”, “/estimation/representative/ID”, and “/estimation/representative/division”.

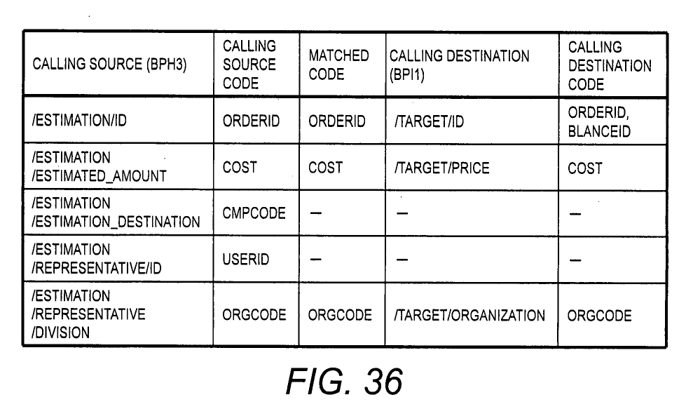

FIG. 36 is a table showing correspondence between data held by the business process of the calling source and data necessary for the business process of the calling destination according to the embodiment of this invention. The table of FIG. 36 includes a data XPath expression and a code of the calling source and a data XPath expression and a code of the calling destination, and matched codes.

First, as described above, the data held by the business process of the calling source and the data necessary for the business process of the calling destination are extracted from the variable definition table 159. The codes of the calling source and the calling destination are compared with each other, and matched data are arranged in the same row. When the calling source or destination includes a plurality of codes, only one of the codes needs to be matched.

Specifically, codes “ORDER ID” and “BARANCE ID” are added to “/target/ID” of the calling destination. A code “ORDER ID” is added to “/estimation/ID” of the calling source. Because the codes “ORDER ID” match each other, correspondence can be judged between “/estimation/ID” of the calling source and “/target/ID” of the calling destination. Other data of the calling destination can similarly be judged to obtain the table shown in FIG. 36.

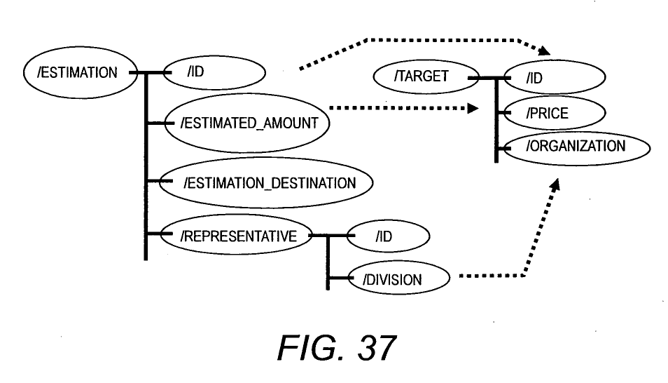

FIG. 37 illustrates correspondence between data held by the business process of the calling source and data necessary for the business process of the calling destination according to the embodiment of this invention. FIG. 37 corresponds to the table shown in FIG. 36. Items of a conversion source and a conversion destination are indicated by arrows of dotted lines.

The case of selecting the approval flow of the “BPI2” will be described. In the approval flow of the “BPI2”, referring to the variable definition table 159, requested data are “/target/ID”, “/target/price”, “/target/organization”, and “/target/comment”. A difference from the BPI1” is whether “/target/comment” is contained in necessary data. Data held by the business process “BPH3” of the calling source are as described above.

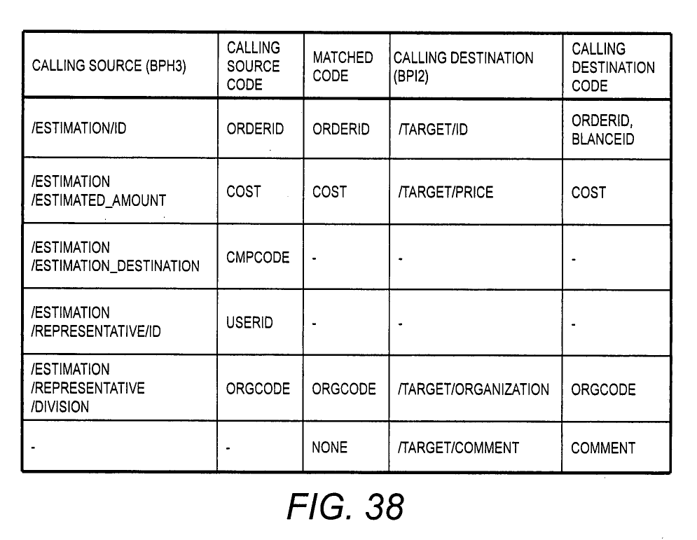

FIG. 38 is a table showing correspondence between data held by the business process of the calling source and data necessary for the business process of the calling destination according to the embodiment of this invention. The table of FIG. 38 is similar in structure to the table of FIG. 36.

For “/target/ID”, “/target/price”, and “/target/organization”, correspondence can be made as in the case of the approval flow of the “BPI1”.

No data matched with a code “COMMENT” of “/target/comment” is contained in the estimation business of the business process “BPH3”. In such a case, because information has to be drawn from the calling source, data necessary for the calling source is automatically added.

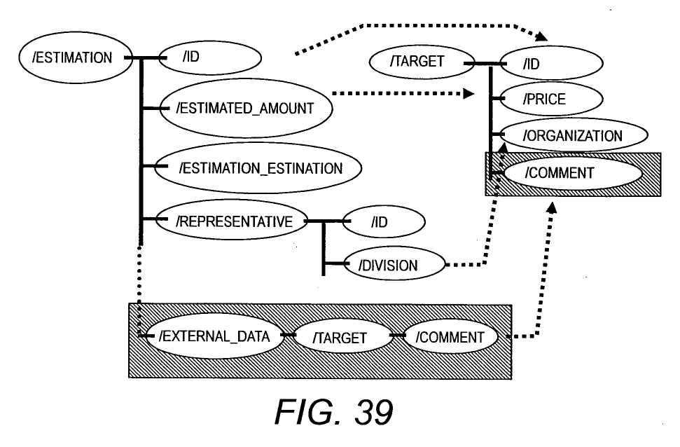

FIG. 39 illustrates correspondence between data held by the business process of the calling source and data necessary for the business process of the calling destination according to the embodiment of this invention. FIG. 39 corresponds to the table of FIG. 38. Items of a conversion source and a conversion destination are indicated by arrows of dotted lines. Shaded areas indicate automatically added items.

As shown in the structure of the left side of FIG. 39, the automatically added items constitute a hierarchy of “external data” from an uppermost tier to match a lower tier of data of the calling destination. Specifically, “/estimation/external_data/target/comment” is added.

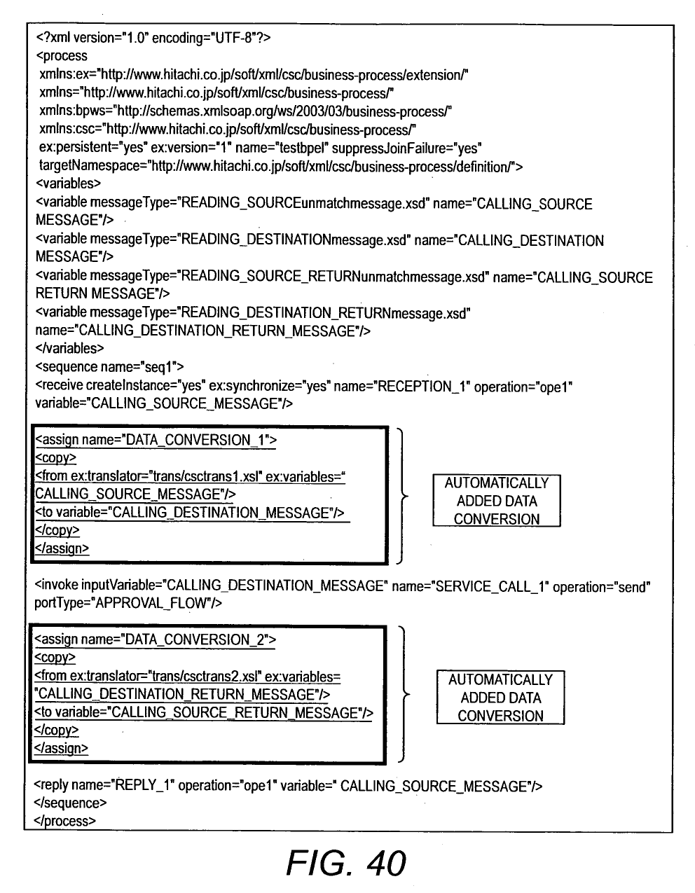

FIG. 40 illustrates an example where a data conversion process is actually added to a BPEL file indicating the business process of the calling source according to the embodiment of this invention. FIG. 40 selectively shows only a part which includes a process of loading “approval flow”.

Areas surrounded with thick lines are automatically added data conversion parts. By converting data before and after execution of “approval flow”, data consistency can be maintained.

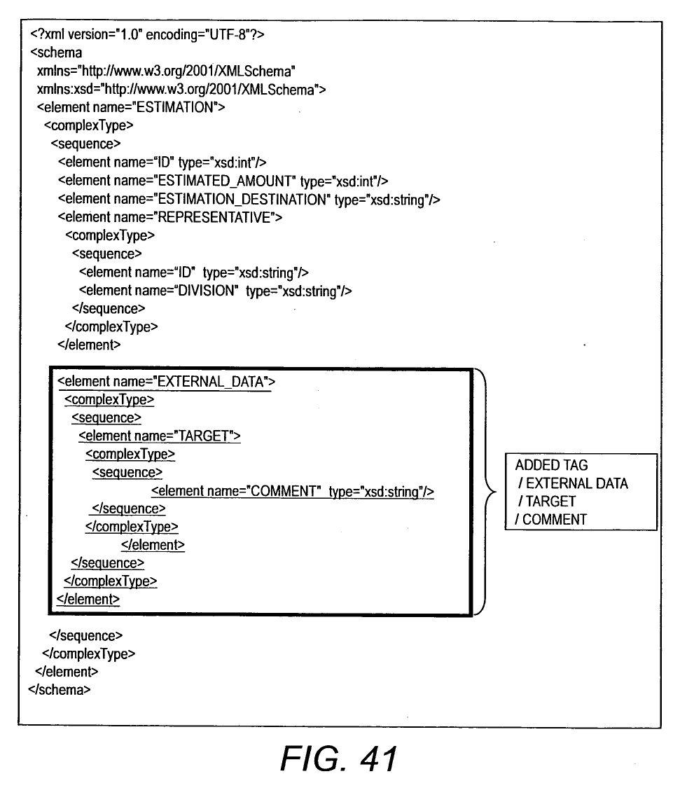

FIG. 41 illustrates an example of an XML schema for defining a data format of the calling source according to the embodiment of this invention.

An area surrounded with a thick line includes automatically added items. As described above, “/estimation/external_data/target/comment” is added to message format information of the calling source.

Through this process, upon completion of the message format correction, according to the business process creation method, definition information of a business flow of an executable format is output.

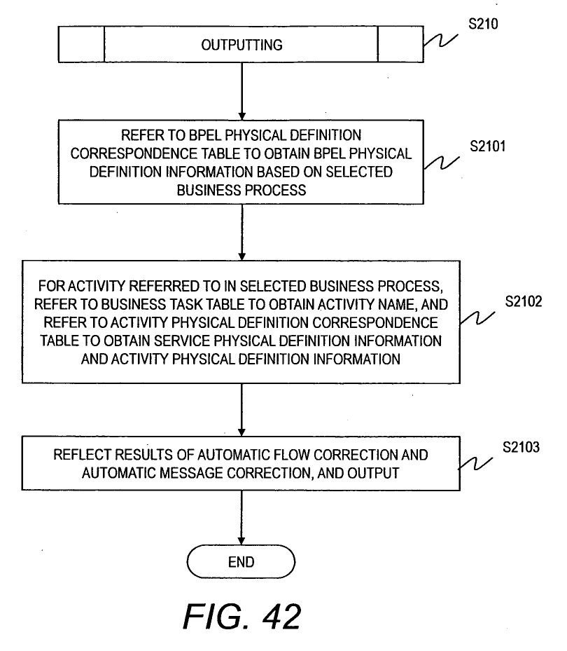

FIG. 42 is a flowchart illustrating a procedure of outputting a business flow of an executable format newly created based on a selected business process according to the embodiment of this invention.

First, the CPU 30 searches the BPEL physical definition correspondence table 160 based on the selected business process to obtain BPEL physical definition information 152 (S2101).

For an activity referred to in the selected business process, the CPU 30 refers to the business task table 156 to obtain an activity name. The CPU 30 refers to the activity physical definition correspondence table 161 to obtain service physical definition information 151 and activity physical definition information 153 (S2102).

Lastly, the CPU 30 reflects correction of a business task name and correction of a message format in the service physical definition information 151, the BPEL physical definition information 152, and the activity physical definition information 153 which have been obtained to output them (S2103).

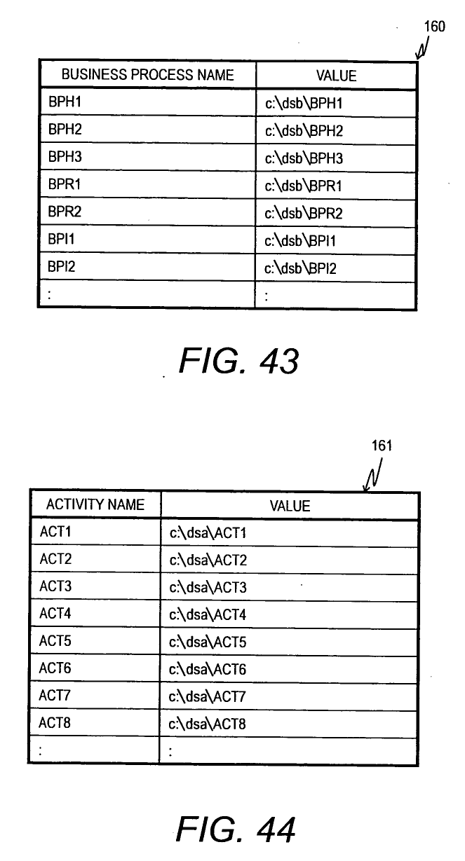

FIG. 43 illustrates a BPEL physical definition correspondence table 160 according to the embodiment of this invention. The BPEL physical definition correspondence table 160 includes a business process name, and a location of actually storing a file of the business process. By holding not the file itself but a storage location, contents can be changed without affecting the system in the case of version upgrading.

FIG. 44 illustrates an activity physical definition correspondence table 161 according to the embodiment of this invention. The activity physical definition correspondence table 161 includes an activity name, an application of the activity, and a location of storing physical definition information.

According to the embodiment of this invention, since a business flow created in the past can be retrieved from the plurality of viewpoints including a business flow shape, a business process including a business flow of a similar shape can be extracted without any dependence on retrieval keywords. As a result, since the business process that becomes a source of a business flow to be created can be accurately retrieved, man-hours necessary for business systematization can be reduced.

According to the embodiment of this invention, even when the business flow includes multiple tiers, a business process can be selected for each tier. Conversion of data transferred between business processes of the tiers can be automatically added. Further, according to the embodiment of this invention, since data is output not in a model but in an executable format, creation efficiency of a business flow can be improved.

Further, according to the embodiment of this invention, since retrieval efficiency is improved, many similar business flows do not have to be created. As a result, business flows can be integrated.

While the present invention has been described in detail and pictorially in the accompanying drawings, the present invention is not limited to such detail but covers various obvious modifications and equivalent arrangements, which fall within the purview of the appended claims.

What is claimed is:

1. A business process creation method executed in a business process creation device for creating a business process for defining a business based on accumulated business processes,
the business process creation device having a processor, a storage unit accessible from the processor, and a business flow input unit for receiving an input of a business flow including a business procedure,
the business process creation method comprising the steps of:
receiving, by the business flow input unit, the input of the business flow to store the input business flow in the storage unit;
extracting, by the processor, a business name of a business corresponding to the input business flow and business information containing business tasks constituting the business from the input business flow;
retrieving, by the processor, at least one similar business process from the accumulated business processes based on the extracted business information;
extracting, by the processor, a flow shape indicating a shape of the business flow from the input business flow;
calculating, by the processor, similarities between the input business flow and the retrieved at least one similar business process, based on the extracted flow shape and a flow shape of a business flow of the retrieved at least one similar business process;
receiving, by the processor, selection of a business process from the retrieved at least one similar business process; and
creating, by the processor, a business process corresponding to the input business flow to output the created business process in an executable format based on the selected business process.

2. The business process creation method according to claim 1, further comprising the steps of:
normalizing, by the processor, the business flow by deleting control information not included in the business procedure from the business flow; the flow shape being represented as a grid graph by representing the normalized business flow with the business tasks set as points and a processing order of the business tasks as a line connected to the points; and
calculating, by the processor, based on the flow shape represented as the grid graph, similarities between the input business flow and the retrieved at least one similar business process.

3. The business process creation method according to claim 2, further comprising the step of matching, by the processor, positions of points corresponding to branching processes included in the flow shape of the input business flow with positions of points corresponding to branching processes included in the flow shape of the business flow of the retrieved at least one similar business process,
wherein similarities between the input business flow and the retrieved at least one similar business process are higher when the number of business tasks in which positions of points other than the matched points are common is larger.

4. The business process creation method according to claim 2, further comprising the step of matching, by the processor, a position of a start point of the flow shape of the input business flow with a position of a start point of the flow shape of the business flow of the retrieved at least one similar business process,
wherein similarities between the input business flow and the retrieved at least one similar business process are higher when the number of business tasks in which positions of points other than the matched points are common is larger.

5. The business process creation method according to claim 1, further comprising the step of calculating, by the processor, for the input business flow and the business flow of the retrieved at least one similar business process, similarities between the input business flow and the retrieved at least one similar business process based on the number of business tasks corresponding to a branching process included in each business flow and the number of branches of each branching process.

6. The business process creation method according to claim 1, further comprising the steps of:
extracting, by the processor, condition information of a branching process included in the input business flow; and
calculating, by the processor, similarities between the input business flow and the retrieved at least one similar business process by comparing the extracted condition information with condition information of a branching process included in the business flow of the retrieved at least one similar business process.

7. The business creation method according to claim 1,
wherein the business process creation device stores a business name of the business, and synonym information containing a business name of a business similar to the business, and
wherein the business creation method further comprises the steps of:
obtaining, by the processor, the business name of the business similar to the business corresponding to the input business flow from the synonym information based on the business name included in the extracted business information; and
retrieving, by the processor, a business process corresponding to the obtained business name as a similar business process from the accumulated business processes.

8. The business process creation method according to claim 1,
wherein the business process includes message format information for defining data to be exchanged with other business processes, and
wherein the business process creation method further comprises the steps of:
creating, by the processor, a business process corresponding to the business task including the plurality of business tasks if the business task included in the input business flow further includes a plurality of business tasks; and
adding, by the processor, an item included in the first message format information but not included in the second message format information to the second message format information if no item included in first message format information contained in the created business process corresponding to the plurality of business tasks is included in second message format information contained in the business process corresponding to the input business flow.

9. The business process creation method according to claim 1, further comprising the step of displaying, by the processor, the business flow of the retrieved at least one similar business process in ascending order of similarities between the input business flow and the retrieved at least one similar business process when selecting a business process which becomes a creation source of the business process corresponding to the input business flow from the retrieved at least one similar business process.

10. The business process creation method according to claim 1, further comprising the step of displaying, by the processor, business tasks commonly included in the business flow of the retrieved at least one similar business process and the input business flow in a way the business tasks are discriminated from business tasks not included in the input business flow when displaying the business flow of the retrieved at least one similar business process.

11. A business process creation device for creating a business process for defining a business based on accumulated business processes, comprising:
a processor;
a storage unit accessible form the processor; and
a business flow input unit for receiving an input of a business flow including a business procedure, wherein:
the business flow input unit receives the input of the business flow to store the input business flow in the storage unit; and
the processor is configured to:
extract a business name of a business corresponding to the input business flow and business information containing business tasks constituting the business from the input business flow;
retrieve, based on the extracted business information, at least one similar business process from the accumulated business processes;
extract a flow shape indicating a shape of the business flow from the input business flow;
calculate, based on the extracted flow shape and a flow shape of a business flow of the retrieved at least one similar business process, similarities between the input business flow and the retrieved at least one similar business process;
receive selection of a business process from the retrieved at least one similar business process; and
create a business process corresponding to the input business flow to output the created business process in an executable format based on the selected business process.

12. A machine-readable medium, containing at least one sequence of instructions that, when executed by a business process creation device for creating a business process for defining a business based on accumulated business processes,
the sequence of instructions causes the business process creation device to:
receive an input of a business flow including a business procedure;
extract a business name of a business corresponding to the input business flow and business information containing business tasks constituting the business from the input business flow;
retrieve, based on the extracted business information, at least one similar business process from the accumulated business processes;
extract a flow shape indicating a shape of the business flow from the input business flow;
calculate, based on the extracted flow shape and a flow shape of a business flow of the retrieved at least one similar business process, similarities between the input business flow and the retrieved at least one similar business process;
receive selection of a business process from the retrieved at least one similar business process; and
create a business process corresponding to the input business flow to output the created business process in an executable format based on the selected business process.
